(19) United States
(12) Patent Application Publication
(10) Pub. No.: US 2015/0074418 A1
(43) Pub. Date: Mar. 12, 2015

(54) METHOD AND APPARATUS FOR OUTPUTTING RECOGNIZED ERROR OF SENSOR IN ELECTRONIC DEVICE

(71) Applicant: Samsung Electronics Co., Ltd., Gyeonggi-do (KR)

(72) Inventors: Yohan LEE, Gyeonggi-do (KR); Mooyoung KIM, Seoul (KR); Gajin SONG, Gyeonggi-do (KR); Jinho HYEON, Gyeonggi-do (KR)

(73) Assignee: Samsung Electronics Co., Ltd., Gyeonnggi-do (KR)

(21) Appl. No.: 14/482,454

(22) Filed: Sep. 10, 2014

(30) Foreign Application Priority Data
Sep. 10, 2013 (KR) 10-2013-0108772

(51) Int. Cl. G06F 21/45; G06F 21/32

(52) U.S. Cl. CPC G06F 21/45; G06F 21/32
USPC 713/186; 726/18

(57) ABSTRACT

A method and an apparatus are provided for operating an electronic device. The electronic device recognizes biometric data of a user that is input to the electronic device. Information related to an input error of the biometric data based on the recognition of the biometric data is presented to the user.

### PRIORITY

This application claims priority under 35 U.S.C. §119(a) to Korean Patent Application No. 10-2013-0108772, filed on Sep. 10, 2013, the content of which is incorporated herein by reference.

### BACKGROUND OF THE INVENTION

1. Field of the Invention

The present invention relates generally to electronic device sensors, and more particularly, to a method and an apparatus for providing a user with a recognized error of a sensor in an electronic device.

2. Description of the Related Art

Sensors are widely used for electronic devices in a variety of fields. For example, fingerprint recognition or iris recognition is being used for security at a door of a house or an office, and various types of biometric technologies, including, for example, fingerprint recognition, are being used in smart phones, tablet computers, notebook computers, and the like, for personal or company network security.

Recognition sensors such as, for example, various cameras or devices for scanning, are used for identifying a user through various biometric technologies including, for example, fingerprint recognition, iris recognition, vein recognition, and the like.

When a biometric operation is first performed in electronic devices using biometrics, a registration procedure is repeatedly carried out, for example, two, three, or more times. Furthermore, for electronic devices configured to identify a user through biometrics, the user may use the corresponding electronic device only if the electronic device is unlocked through the configured biometric method.

However, when the user wants to register information on his/her specific body part, such as, for example, a fingerprint, an iris, a vein, and the like, in the electronic device, or unlock the corresponding electronic device through the registered biometric method, the sensors may not correctly recognize biometric information due to carelessness or an erroneous input of the user.

When the sensors do not normally operate as described above, each of the electronic devices notifies the user of the input error, by providing a preconfigured voice message, such as, for example, “Input is incorrect”, “You are an unregistered user”, “Please input again”, or the like, or a text form corresponding to the aforementioned voice message. Since the user is notified of the input error through the text or the simple voice message, the user frequently has to input the biometric information again while not accurately recognizing the type of error that has occurred.

Although a particular electronic device may provide the type of input error when providing the erroneous input through a text or voice during performance of biometrics, use of the biometrics is cumbersome and inconvenient. In addition, since the user finds it tedious for the input error to be provided in the simple text form, it is not widely used.

### SUMMARY OF THE INVENTION

The present invention has been made to address at least the above problems and/or disadvantages and to provide at least the advantages described below. Accordingly, an aspect of the present invention provides a biometric method and a biometric device that can enhance user convenience when using an electronic device.

Another aspect of the present invention provides a method and a device for enabling a user to intuitively appreciate an error occurring in an electronic device during performance of biometrics.

Another aspect of the present invention provides a method and a device that can enhance a user's accessibility and usability of an electronic device using biometrics.

Another aspect of the present invention provides a method and a device that can induce a user to effectively perform a biometric operation in an electronic device using biometrics.

In accordance with an aspect of the present invention, a method is provided for operating an electronic device. The electronic device recognizes biometric data of a user that is input to the electronic device. Information related to an input error of the biometric data based on the recognition of the biometric data is presented to the user.

In accordance with another aspect of the present invention, an electronic device is provided that includes a recognition module configured to recognize biometric data of at least a part of a body of a user that is input to the electronic device. The electronic device also includes an output module configured to present information related to the biometric data to the user. The electronic device further includes a control module configured to output error information corresponding to an input error of the biometric data through the output module when the input error of the biometric data is sensed based on the recognition.

In accordance with a further aspect of the present invention, a method is provided for operating an electronic device. The electronic device recognizes a plurality of pieces of biometric data corresponding to a specific body part of a user based on a plurality of inputs to the electronic device. For each of the plurality of pieces of biometric data, at least one of information as to whether recognition succeeds, information on an error occurring during the recognition, and information on a result obtained by comparing a first of the plurality of pieces of biometric data corresponding to a first of the plurality of inputs and a second of the plurality of pieces of biometric data corresponding to a second of the plurality of inputs, is presented to the user.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram illustrating an electronic device, according to an embodiment of the present invention;

FIG. 2 is a block diagram illustrating hardware, according to an embodiment of the present invention;

FIG. 3 is a block diagram illustrating a programming module, according to an embodiment of the present invention;

FIG. 4 is a block diagram illustrating modules in which hardware and software of an electronic device for biometrics are combined, according to an embodiment of the present invention;

FIG. 5 is a flowchart illustrating registration and authentication operations using biometrics in an electronic device for biometrics, according to an embodiment of the present invention;

FIG. 6 is a flowchart illustrating an authentication operation using biometrics in an electronic device for biometrics, according to an embodiment of the present invention;

FIG. 7 is a flowchart illustrating a registration operation using biometrics in an electronic device for biometrics, according to an embodiment of the present invention;

FIGS. 8A and 8B illustrate a general input request window for biometric information in an electronic device;

FIGS. 9A to 9E illustrate message output in response to a normal operation and an error of biometrics in an electronic device performing the biometrics, according to an embodiment of the present invention;

FIGS. 10A to 10C illustrate message output in response to an error of biometrics in an electronic device performing the biometrics, according to an embodiment of the present invention;

FIGS. 11A to 11G illustrate message output in response to a normal input and an erroneous input of biometrics in an electronic device performing the biometrics, according to an embodiment of the present invention;

FIGS. 12A to 12H illustrate message output in response to a normal input and an erroneous input of biometrics in an electronic device performing the biometrics, according to an embodiment of the present invention;

FIGS. 13A to 13F illustrate message output in response to a normal input and an erroneous input when biometric information is registered in an electronic device performing the biometrics, according to an embodiment of the present invention

FIGS. 14A to 14F illustrate message output in response to a normal input and an erroneous input when biometric information is registered in an electronic device performing the biometrics, according to an embodiment of the present invention;

FIGS. 15A to 15F illustrate message output in response to a normal input and an erroneous input when biometric information is registered in an electronic device performing the biometrics, according to an embodiment of the present invention; and

FIGS. 16A to 16F illustrate message output in response to a normal input and an erroneous input when biometric information is registered in an electronic device performing the biometrics, according to an embodiment of the present invention.

### DETAILED DESCRIPTION OF THE EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

The terms and words used in the following description and claims are not limited to their dictionary meanings, but, are merely used to enable a clear and consistent understanding of the present invention.

It is to be understood that the singular forms “a,” “an,” and “the” include plural referents unless the context clearly dictates otherwise. Thus, for example, reference to “a component surface” includes reference to one or more of such surfaces.

Expressions such as “include” and “may include”, which may be used herein, denote the presence of the disclosed functions, operations, and constituent elements, and do not limit one or more additional functions, operations, and constituent elements. Terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Furthermore, the expression “and/or” includes any and all combinations of the associated listed words. For example, the expression “A and/or B” may include A, may include B, or may include both A and B.

Expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, a first element could be termed a second element, and similarly, a second element could be also termed a first element without departing from the scope of the present invention.

In the case where a component is referred to as being “connected to” or “accessed by” another component, it should be understood that not only may the component be directly connected to or accessed by the other component, but there also may exist another component between them. When a component is referred to as being “directly connected to” or “directly accessed by” another component, it should be understood that there is no component therebetween. The terms used herein are only used to describe specific embodiments of the present invention, and are not intended to limit the present invention. As used herein, the singular forms are intended to include the plural forms as well, unless the context clearly indicates otherwise.

An electronic device, according to embodiments of the present invention, may be a device including a communication function. For example, the device corresponds to a combination of at least one of a smartphone, a tablet personal computer (PC), a mobile phone, a video phone, an e-book reader, a desktop PC, a laptop PC, a netbook computer, a personal digital assistant (PDA), a portable multimedia player (PMP), a digital audio player, a mobile medical device, an electronic bracelet, an electronic necklace, an electronic accessory, a camera, a wearable device, an electronic clock, a wrist watch, home appliances (for example, an air-conditioner, a vacuum, an oven, a microwave, a washing machine, an air cleaner, and the like), an artificial intelligence robot, a television (TV), a digital versatile disc (DVD) player, an audio device, various medical devices (for example, magnetic resonance angiography (MRA), magnetic resonance imaging (MRI), computed tomography (CT), a scanning machine, a ultrasonic wave device, or the like), a navigation device, a global positioning system (GPS) receiver, an event data recorder (EDR), a flight data recorder (FDR), a set-top box, a TV box, an electronic dictionary, vehicle infotainment device, an electronic equipment for a ship (for example, navigation equipment for a ship, gyrocompass, or the like), avionics, a security device, electronic clothes, an electronic key, a camcorder, game consoles, a head-mounted display (HMD), a flat panel display device, an electronic frame, an electronic album, furniture or a portion of a building/structure that includes a communication function, an electronic board, an electronic signature receiving device, a projector, and the like. It is obvious to those skilled in the art that the electronic device, according to embodiments of the present invention, is not limited to the aforementioned devices.

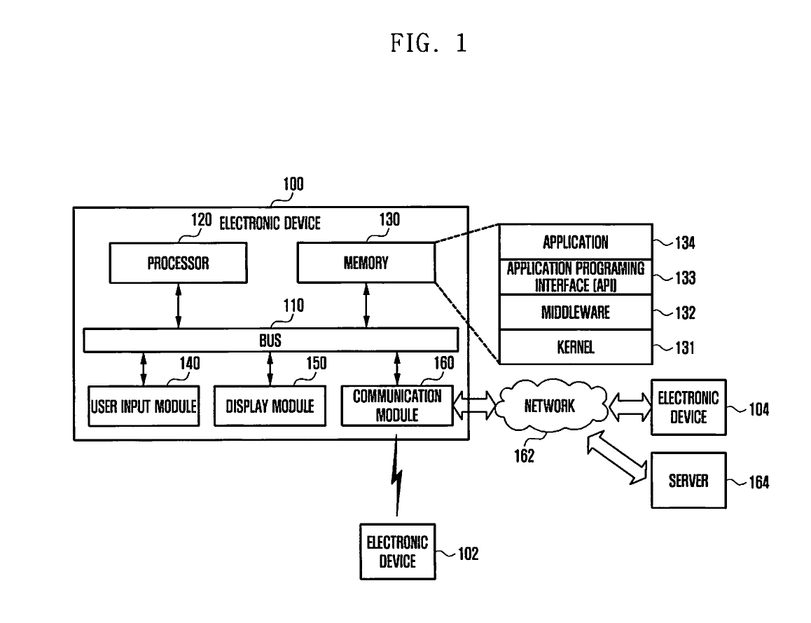

FIG. 1 is a block diagram illustrating a configuration of an electronic device, according to an embodiment of the present invention.

Referring to FIG. 1, an electronic device 100 includes a bus 110, a processor 120, a memory 130, a user input module 140, a display module 150, a communication module 160, and other similar and/or suitable components.

The bus 110 may be a circuit that interconnects the above-described elements and delivers a communication (e.g., a control message) between the above-described elements.

The processor 120 may receive commands from the above-described other elements (e.g., the memory 130, the user input module 140, the display module 150, the communication module 160, etc.) through the bus 110, may interpret the received commands, and may execute calculation or data processing according to the interpreted commands.

The memory 130 may store commands or data received from the processor 120 or other elements (e.g., the user input module 140, the display module 150, the communication module 160, etc.) or generated by the processor 120 or the other elements. The memory 130 includes programming modules, such as a kernel 131, middleware 132, an application programming interface (API) 133, an application 134, and the like. Each of the above-described programming modules may be implemented in software, firmware, hardware, or a combination of two or more thereof.

The kernel 131 may control or manage system resources (e.g., the bus 110, the processor 120, the memory 130, etc.) used to execute operations or functions implemented by other programming modules (e.g., the middleware 132, the API 133, and the application 134). Also, the kernel 131 may provide an interface capable of accessing and controlling or managing the individual elements of the electronic device 100 by using the middleware 132, the API 133, or the application 134.

The middleware 132 may serve to go between the API 133 or the application 134 and the kernel 131 in such a manner that the API 133 or the application 134 communicates with the kernel 131 and exchanges data therewith. Also, in relation to work requests received from one or more applications 134 and/or the middleware 132, for example, may perform load balancing of the work requests by using a method of assigning a priority, in which system resources (e.g., the bus 110, the processor 120, the memory 130, etc.) of the electronic device 100 can be used, to at least one of the one or more applications 134.

The API 133 is an interface through which the application 134 is capable of controlling a function provided by the kernel 131 or the middleware 132, and may include, for example, at least one interface or function for file control, window control, image processing, character control, or the like.

The user input module 140, for example, may receive a command or data as input from a user, and may deliver the received command or data to the processor 120 or the memory 130 through the bus 110.

The display module 150 may display a video, an image, data, or the like to the user.

The communication module 160 may connect communication between another electronic device 102 and the electronic device 100. The communication module 160 may support a predetermined short-range communication protocol (e.g., Wi-Fi, BlueTooth (BT), and near field communication (NFC)), or predetermined network communication 162 (e.g., the Internet, a local area network (LAN), a wide area network (WAN), a telecommunication network, a cellular network, a satellite network, a plain old telephone service (POTS), or the like). Each of electronic devices 102 and 104 may be a device which is identical (e.g., of an identical type) to or different (e.g., of a different type) from the electronic device 100. Further, the communication module 160 may connect communication between a server 164 and the electronic device 100 via the network 162.

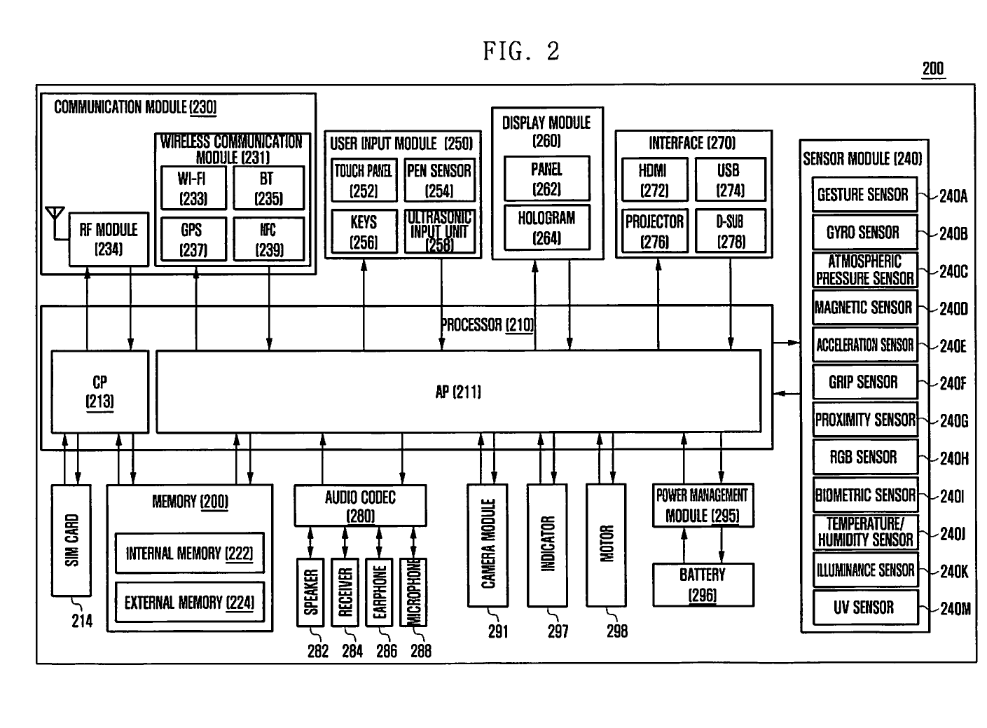

FIG. 2 is a block diagram illustrating a configuration of hardware, according to an embodiment of the present invention.

Hardware 200 may be, for example, the electronic device 100 illustrated in FIG. 1.

Referring to FIG. 2, the hardware 200 includes one or more processors 210, a subscriber identification module (SIM) card 214, a memory 220, a communication module 230, a sensor module 240, a user input module 250, a display module 260, an interface 270, an audio coder/decoder (codec) 280, a camera module 291, a power management module 295, a battery 296, an indicator 297, a motor 298 and any other similar and/or suitable components.

The processor 210 (e.g., the processor 120) includes one or more application processors (APs) 211, or one or more communication processors (CPs) 213. The AP 211 and the CP 213 are illustrated as being included in the processor 210 in FIG. 2, but may be included in different integrated circuit (IC) packages. According to an embodiment of the present invention, the AP 211 and the CP 213 may be included in one IC package.

The AP 211 may execute an operating system (OS) or an application program, and thereby may control multiple hardware or software elements connected to the AP 211, and may perform processing of and arithmetic operations on various data including multimedia data. The AP 211 may be implemented by, for example, a system on chip (SoC). According to an embodiment of the present invention, the processor 210 may further include a graphical processing unit (GPU).

The CP 213 may manage a data line and may convert a communication protocol in the case of communication between the electronic device (e.g., the electronic device 100) including the hardware 200 and different electronic devices connected to the electronic device through the network. The CP 213 may be implemented by, for example, an SoC. According to an embodiment of the present invention, the CP 213 may perform at least some of multimedia control functions. The CP 213, for example, may distinguish and authenticate a terminal in a communication network by using a subscriber identification module (e.g., the SIM card 214). Also, the CP 213 may provide the user with services, such as a voice telephony call, a video telephony call, a text message, packet data, and the like.

Further, the CP 213 may control the transmission and reception of data by the communication module 230. In FIG. 2, elements such as the CP 213, the power management module 295, the memory 220, and the like are illustrated as elements separate from the AP 211. However, according to an embodiment of the present invention, the AP 211 may include at least some (e.g., the CP 213) of the above-described elements.

According to an embodiment of the present invention, the AP 211 or the CP 213 may load, to a volatile memory, a command or data received from at least one of a non-volatile memory and other elements connected to each of the AP 211 and the CP 213, and may process the loaded command or data. Also, the AP 211 or the CP 213 may store, in a non-volatile memory, data received from or generated by at least one of the other elements.

The SIM card 214 may be a card implementing a subscriber identification module, and may be inserted into a slot formed in a particular portion of the electronic device 100. The SIM card 214 may include unique identification information (e.g., integrated circuit card identifier (ICCID)) or subscriber information (e.g., international mobile subscriber identity (IMSI)).

The memory 220 includes an internal memory 222 and an external memory 224. The memory 220 may be, for example, the memory 130 illustrated in FIG. 1. The internal memory 222 may include, for example, at least one of a volatile memory (e.g., a dynamic RAM (DRAM), a static RAM (SRAM), a synchronous dynamic RAM (SDRAM), etc.), and a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a not AND (NAND) flash memory, a not OR (NOR) flash memory, etc.). According to an embodiment of the present invention, the internal memory 222 may be in the form of a solid state drive (SSD). The external memory 224 may further include a flash drive, for example, a compact flash (CF), a secure digital (SD), a micro-secure digital (Micro-SD), a mini-secure digital (Mini-SD), an extreme digital (xD), a memory stick, or the like.

The communication module 230 includes a wireless communication module 231 or a radio frequency (RF) module 234. The communication module 230 may be, for example, the communication module 160 illustrated in FIG. 1. The wireless communication module 231 includes, for example, a Wi-Fi part 233, a BT part 235, a GPS part 237, or a NFC part 239. For example, the wireless communication module 231 may provide a wireless communication function by using a radio frequency. Additionally or alternatively, the wireless communication module 231 may include a network interface (e.g., a LAN card), a modulator/demodulator (modem), or the like for connecting the hardware 200 to a network (e.g., the Internet, a LAN, a WAN, a telecommunication network, a cellular network, a satellite network, a POTS, or the like).

The RF module 234 may be used for transmission and reception of data, for example, transmission and reception of RF signals or called electronic signals. The RF unit 234 may include, for example, a transceiver, a power amplifier module (PAM), a frequency filter, a low noise amplifier (LNA), or the like. Also, the RF module 234 may further include a component for transmitting and receiving electromagnetic waves in a free space in a wireless communication, for example, a conductor, a conductive wire, or the like.

The sensor module 240 includes, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a red, green and blue (RGB) sensor 240H, a biometric sensor 240I, a temperature/humidity sensor 240J, an illuminance sensor 240K, and an ultra violet (UV) sensor 240M. The sensor module 240 may measure a physical quantity or may sense an operating state of the electronic device 100, and may convert the measured or sensed information to an electrical signal. Additionally/alternatively, the sensor module 240 may include, for example, an e-nose sensor, an electromyography (EMG) sensor, an electroencephalogram (EEG) sensor, an electrocardiogram (ECG) sensor, a fingerprint sensor, and the like. The sensor module 240 may further include a control circuit for controlling one or more sensors included therein.

The user input module 250 includes a touch panel 252, a pen sensor 254 (e.g., a digital pen sensor), keys 256, and an ultrasonic input unit 258. The user input module 250 may be, for example, the user input module 140 illustrated in FIG. 1. The touch panel 252 may recognize a touch input in at least one of, for example, a capacitive scheme, a resistive scheme, an infrared scheme, and an acoustic wave scheme. Also, the touch panel 252 may further include a controller. In the capacitive scheme, the touch panel 252 is capable of recognizing proximity as well as a direct touch. The touch panel 252 may further include a tactile layer. In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to sense a sound wave by using a microphone (e.g., a microphone 288) of the terminal through a pen generating an ultrasonic signal, and to identify data. The ultrasonic input unit 258 is capable of wireless recognition. According to an embodiment of the present invention, the hardware 200 may receive a user input from an external device (e.g., a network, a computer, or a server), which is connected to the communication module 230, through the communication module 230.

The display module 260 includes a panel 262 or a hologram 264. The display module 260 may be, for example, the display module 150 illustrated in FIG. 1. The panel 262 may be, for example, a liquid crystal display (LCD), an active matrix organic light emitting diode (AM-OLED) display, or the like. The panel 262 may be implemented so as to be, for example, flexible, transparent, or wearable. The panel 262 may include the touch panel 252 and one module. The hologram 264 may display a three-dimensional image in the air by using interference of light. According to an embodiment of the present invention, the display module 260 may further include a control circuit for controlling the panel 262 or the hologram 264.

The interface 270 includes, for example, a high-definition multimedia interface (HDMI) 272, a universal serial bus (USB) 274, a projector 276, and a D-subminiature (D-sub) 278. Additionally or alternatively, the interface 270 may include, for example, SD/multi-media card (MMC) or infrared data association (IrDA).

The audio codec 280 may bidirectionally convert between a voice and an electrical signal. The audio codec 280 may convert voice information, which is input to or output from the audio codec 280, through, for example, a speaker 282, a receiver 284, an earphone 286, the microphone 288, or the like.

The camera module 291 may capture an image and a moving image. According to an embodiment of the present invention, the camera module 291 may include one or more image sensors (e.g., a front lens or a back lens), an image signal processor (ISP), and a flash LED (not illustrated).

The power management module 295 may manage power of the hardware 200. The power management module 295 may include, for example, a power management integrated circuit (PMIC), a charger integrated circuit (IC), or a battery fuel gauge.

The PMIC may be mounted to, for example, an IC or a SoC semiconductor. Charging methods may be classified into a wired charging method and a wireless charging method. The charger IC may charge a battery, and may prevent an overvoltage or an overcurrent from a charger to the battery. According to an embodiment of the present invention, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, etc.) for wireless charging may be added in order to perform the wireless charging.

The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the hardware 200 or a part (e.g., the AP 211) of the hardware 200, for example, a booting state, a message state, a charging state and the like. The motor 298 may convert an electrical signal into a mechanical vibration. The processor 210 may control the sensor module 240.

The hardware 200 may include a processing unit (e.g., a GPU) for supporting a module TV. The processing unit for supporting a module TV may process media data according to standards such as, for example, digital multimedia broadcasting (DMB), digital video broadcasting (DVB), media flow, and the like. Each of the above-described elements of the hardware 200, according to an embodiment of the present invention, may include one or more components, and the name of the relevant element may change depending on the type of electronic device. The hardware 200, according to an embodiment of the present invention, may include at least one of the above-described elements. Some of the above-described elements may be omitted from the hardware 200, or the hardware 200 may further include additional elements. Also, some of the elements of the hardware 200, according to an embodiment of the present invention, may be combined into one entity, which may perform functions identical to those of the relevant elements before the combination.

The term “module” used herein may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be implemented mechanically or electronically. For example, the “module”, according to an embodiment of the present invention, may include at least one of an application-specific integrated circuit (ASIC) chip, a field-programmable gate array (FPGA), and a programmable-logic device for performing certain operations, which have been known or are to be developed in the future.

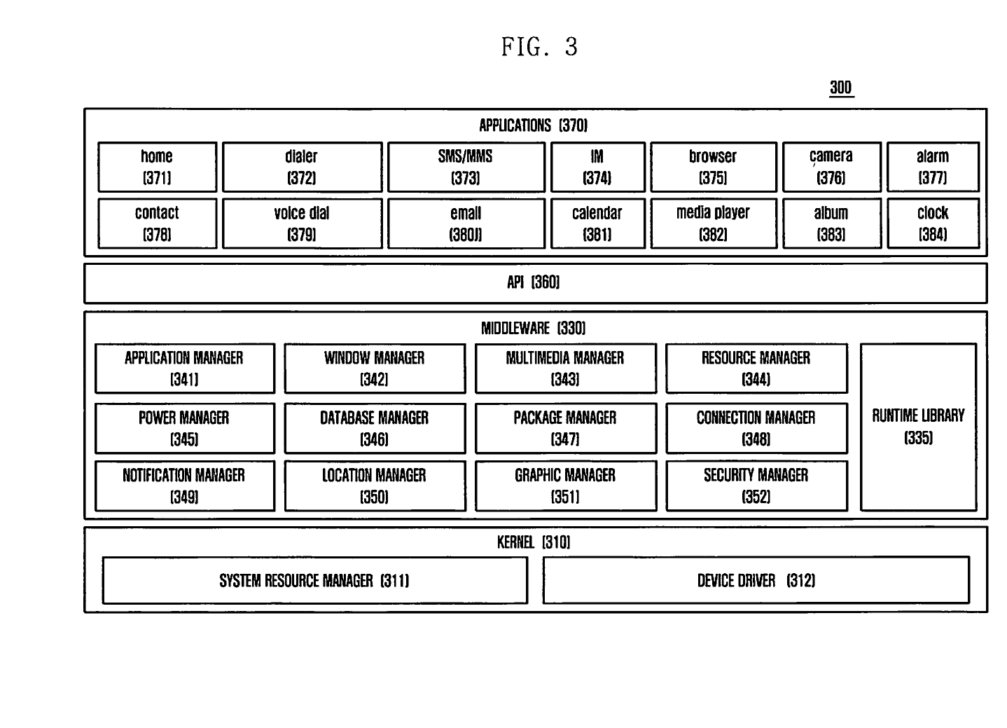

FIG. 3 is a block diagram illustrating a configuration of a programming module, according to an embodiment of the present invention.

A programming module 300 may be included (or stored) in the electronic device 100 (e.g., the memory 130) illustrated in FIG. 1, or may be included (or stored) in the electronic device 200 (e.g., the memory 230) illustrated in FIG. 2. At least a part of the programming module 300 may be implemented in software, firmware, hardware, or a combination of two or more thereof. The programming module 300 may be implemented in hardware (e.g., the hardware 200), and may include an OS controlling resources related to an electronic device (e.g., the electronic device 100) and/or various applications (e.g., an application 370) executed in the OS.

Referring to FIG. 3, the programming module 300 includes a kernel 310, a middleware 330, an API 360, and/or the application 370.

The kernel 310 (e.g., the kernel 131) includes a system resource manager 311 and/or a device driver 312. The system resource manager 311 may include, for example, a process manager, a memory manager, and a file system manager. The system resource manager 311 may perform the control, allocation, recovery, and/or the like of system resources. The device driver 312 may include, for example, a display driver, a camera driver, a Bluetooth driver, a shared memory driver, a USB driver, a keypad driver, a Wi-Fi driver, and/or an audio driver. Also, according to an embodiment of the present invention, the device driver 312 may include an inter-process communication (IPC) driver.

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 132) includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a compiler, in order to add a new function by using a programming language during the execution of the application 370. According to an embodiment of the present invention, the runtime library 335 may perform functions that are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a Basic Input/Output System (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like, in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present invention, when the electronic device (e.g., the electronic device 100) has a telephone function, the middleware 330 may further include a telephony manager for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present invention, may further include other elements, or may replace the some of the elements with elements, each of which performs a similar function and has a different name.

The API 360 (e.g., the API 133) is a set of API programming functions, and may be provided with a different configuration according to an OS. For example, one API set may be provided to each platform. Also, for example, two or more API sets may be provided to each platform.

The applications 370 (e.g., the applications 134) may include, for example, a preloaded application and/or a third party application. The applications 370 (e.g., the applications 134) include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 220. At least a part of the programming module 300 may be implemented (e.g., executed) by, for example, the one or more processors 210. At least a part of the programming module 300 may include, for example, a module, a program, a routine, a set of instructions, and/or a process for performing one or more functions.

Names of the elements of the programming module (e.g., the programming module 300), according to an embodiment of the present invention, may change depending on the type of OS. The programming module, according to an embodiment of the present invention, may include one or more of the above-described elements. Alternatively, some of the above-described elements may be omitted from the programming module. Alternatively, the programming module may further include additional elements. The operations performed by the programming module or other elements, according to an embodiment of the present invention, may be processed in a sequential method, a parallel method, a repetitive method, or a heuristic method. Also, some of the operations may be omitted, or other operations may be added to the operations.

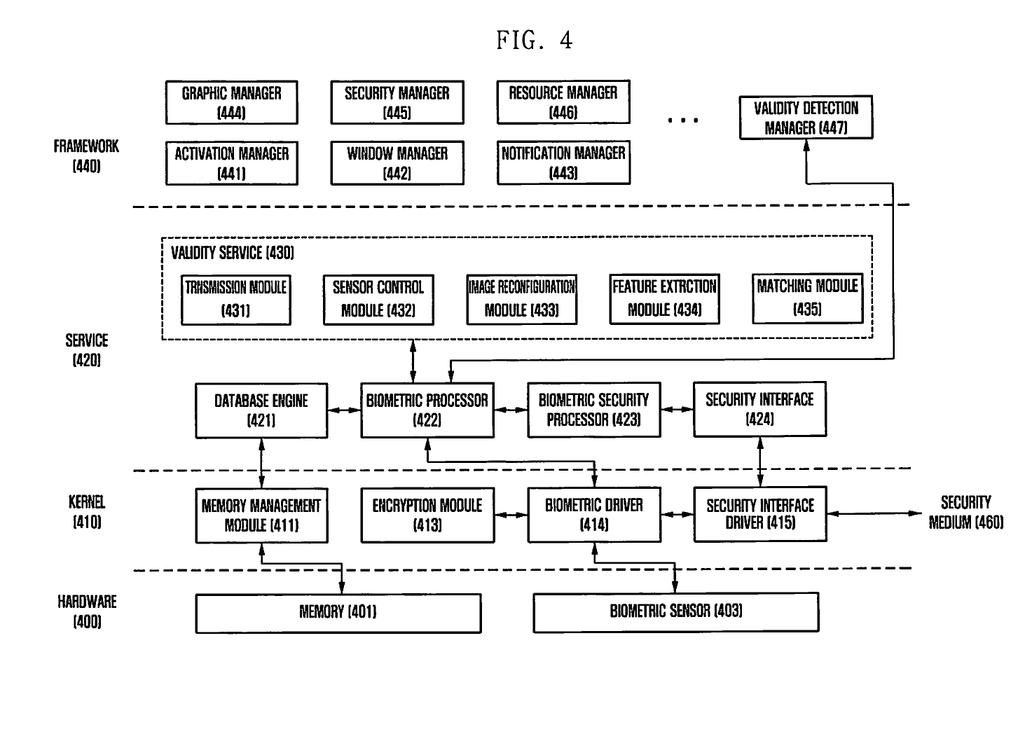

FIG. 4 is a block diagram illustrating modules in which hardware and software of an electronic device for biometrics are combined, according to an embodiment of the present invention.

Hardware 400 includes a memory 401 and a biometric sensor 403. The memory 401 may store various types of registered data for biometrics, for example, registered fingerprint data, registered iris data of an eyeball, registered vein data, and the like. The memory 401 may be a part of the memory 130 of FIG. 1 and a part of the memory 204 of FIG. 2.

The biometric sensor 403 is a sensor for biometrics, and may be a fingerprint sensor or a scanner for fingerprint data, or a digital camera or a special camera for recognizing iris data of an eyeball or vein data. The biometric sensor 403 may also be configured with a different type of sensor or module in addition to those described above. Accordingly, the biometric sensor 403 may be included in the sensor module 240, and may include the camera module 291 in some cases.

A kernel 410, a service 420, a validity service 430, and a framework 440, which are modules configuring software may be included in the kernel 310, the middleware 330, and the API 360 illustrated in FIG. 3, and may correspond to the kernel 131, the middleware 132, and the application program interface 133, which are included in the memory 130 of FIG. 1. Accordingly, it should be noted that the applications 134 of FIG. 1 and the applications 370 of FIG. 3 are not illustrated in FIG. 4.

The kernel 410 includes a memory management module 411, an encryption module 413, a biometric driver 414, and a security interface driver 415. The memory management module 411 performs a control to store biometric data registered for biometrics as is or through encryption thereof.

The encryption module 413 encrypts data sensed by the biometric sensor 403 according to a preset method. Furthermore, the encryption module 413 may also transfer an encryption key to the biometric driver 414 in a process in which encryption is directly carried out in the biometric driver 414. The encryption module 413 is placed in the kernel 410 due to the fact that a security problem such as hacking may arise when the acquired raw biometric information is provided to the higher hierarchy. The encryption module 143 may be excluded according to an implementation method thereof.

The biometric driver 414 controls the biometric sensor 403 to acquire specific biometric data of a user. The biometric driver 414 encrypts the biometric data acquired in this way through the encryption module 413. Alternatively, when encryption is directly carried out in the biometric driver 414, the encryption module 413 may also transfer an encryption key to the biometric driver 414. The biometric driver 414 may receive the encryption key for encrypting the biometric data from the encryption module 413 and directly perform encryption. The biometric driver 414 provides the encrypted biometric data to a biometric processor 422.

The security interface driver 415 may perform a control to transmit and receive a security key or security required data to/from a security area within an electronic device, for example, a specific area of the memory where security is configured. Furthermore, the security interface driver 415 may perform a control to transmit and receive a security key or security required data to/from an outside of the electronic device, for example, another electronic device for which security is enhanced through a specific network, or a server for which security is configured.

The service 420 includes a database engine 421, the biometric processor 422, a biometric security processor 423, a security interface 424, and the validity service 430. The validity service 430 includes a transmission module 431, a sensor control module 432, an image reconfiguration module 433, a feature extraction module 434, and a matching module 435.

The database engine 421 receives biometric data requested to be registered, provides the corresponding data to the memory management module 411, and controls the memory management module 411 to store the data in the memory 401. Furthermore, when the registered biometric data is requested, the database engine 421 receives the biometric data stored in the memory 401 from the memory management module 411 to provide the received biometric data to the biometric processor 422.

The biometric processor 422 controls the biometric driver 414, such that the biometric sensor 403 performs photography or scans for biometrics. The biometric processor 422, when receiving biometric data, may differently perform two operations.

When registering the biometric data, the biometric driver 414 provides the acquired biometric data to the database engine 421, such that the biometric data is stored in the memory 401. Furthermore, when a specific operation is requested through biometrics, for example, when a determination as to whether biometric data accords with registered data is to be made for unlocking, the biometric processor 422 provides data received from the biometric sensor 403 and data stored in the memory 401 to the validity service 430, and allows the validity service 430 to determine accord or discord thereof.

Since biometric data received from the kernel 410 has already been encrypted, the biometric security processor 423 decrypts the encrypted biometric data to provide it to the biometric processor 422.

The security interface 424 is an interface for acquiring, from a security area, a key for encryption, such as a specific security key for an operation of the biometric security processor 423. The security interface 424 may receive encrypted data or a key for encryption from the memory of the electronic device in which a specific security area is configured, another external electronic device for which security is enhanced, or a server for which security is requested.

The sensor control module 432 controls an overall operation of the biometric sensor 403. For example, when various types of data are acquired through the biometric sensor 403 capable of recognizing features of a person, the sensor control module 432 performs a function of determining in advance various factors having an influence on quality of input data such as a biometric input speed and/or sensitivity or a distance of a camera or microphone. The sensor control module 432 controls the overall operation of the biometric sensor 403. For example, when various types of data are acquired through the biometric sensor 403 capable of recognizing features of a person, the sensor control module 432 performs a control for a scan speed, sensitivity of photography, a distance, and the like.

The image reconfiguration module 433 reconfigures data acquired from the biometric sensor 403 in a preset form. For example, when a user is identified by fingerprint data, a shape of a fingerprint, an area for acquisition of the fingerprint, and a data size may be configured. Also, for any shape capable of identifying a person, such as a shape of an iris of an eyeball, a shape of a vein, a shape of an ear, and the like, there may be a preset size for extracting the corresponding shape. The image reconfiguration module 433 may reconfigure the acquired information as data with a preset area or size.

The feature extraction module 434 extracts feature data from the particular size of data converted by the image reconfiguration module 433. For example, for a fingerprint, there are fingerprint distinction points for identifying a person, such as a point where a curve is bent, and a point where circles gather. The feature extraction module 434 extracts the distinguished feature points from the biometric data normalized in the particular size.

The image reconfiguration module 433 and the feature extraction module 434 may also be configured as one module.

The matching module 435 compares the data stored in advance in the memory 401 with the currently extracted data to determine whether the two pieces of data accord with each other or whether the two pieces of data have a difference smaller than a preset threshold value. When it is determined that the two pieces of data accord with each other or have the difference smaller than the preset threshold value, the matching module 435 may determine that the two pieces of data match each other. The matching module 435 may provide the biometric processor 422 with the result as to whether the two pieces of data match each other.

Next, managers configuring the framework 440 will be described. The framework 440 includes an activation manager 441, a window manager 442, a notification manager 443, a graphic manager 444, a security manager 445, a resource manager 446, a validity detection manager 447, and the like.

The activation manager 441 may receive information as to whether the electronic device is activated and activate a display module and input modules. The window manager 442 may manage GUI resources used on the screen. The notification manager 443 may display or notify of an event such as an arrival message, an appointment, a proximity notification, or the like. The graphic manager 444 may manage a graphic effect provided to a user or a user interface related to the graphic effect. The security manager 445 may provide all security functions required for system security or user authentication. The resource manager 446 may manage resources, such as a source code, a memory, or a storage space, of at least one application. The validity detection manager 447 performs a function of displaying, to a user, the result transferred from the validity service 430. That is, the validity detection manager 447 displays messages related to errors occurring in the image reconfiguration module 433 and the feature extraction module 434, or the user authentication result determined by the matching module 435.

A registration operation for biometrics and an authentication operation through a comparison with registered information, using the device of FIG. 4 and having the aforementioned configurations, is described in greater detail below.

For convenience of description, it is assumed in the following description that biometrics is carried out through fingerprint recognition, and the biometric sensor 403 is a sensor for the fingerprint recognition. First, an operation of inputting a fingerprint will be described.

When a user performs an action such as a touch, the biometric sensor 403 may acquire information that the user wants to make an input to a fingerprint sensor. When the touch action is made in this way, the biometric sensor 403 may provide the biometric driver 414 with information for notifying that the user desires the fingerprint to be recognized, for example, touch information.

Accordingly, the biometric driver 414, when receiving a request for the fingerprint recognition, may provide the request to the biometric processor 422 and allow the biometric processor 422 to receive biometric data of the user through the biometric sensor 403. At this time, the data received from the biometric sensor 403 is unprocessed raw data.

When receiving the raw data, the biometric driver 414 provides the raw data to the encryption module 413, such that the encryption module 413 encrypts the raw data based on the preset encryption method, and then receives the encrypted data from the encryption module 413. Furthermore, the biometric driver 414 may receive an encryption key for encrypting the raw data from the encryption module 413 and directly encrypt the raw data. The biometric driver 414 provides the received encrypted data to the biometric processor 422.

The biometric processor 422, when receiving the encrypted biometric data, provides it to the biometric security processor 423, and the biometric security processor 423 decodes the encrypted biometric data. The biometric security processor 423 has data to decipher the encryption carried out by the encryption module 413, and therefore, may decode the encrypted biometric data. The biometric security processor 423 provides the decoded biometric data to the biometric processor 422.

Hereinafter, an operation of comparing the biometric data acquired by the biometric sensor 403 with pre-registered biometric data will be described.

The biometric processor 422 requests the database engine 421 to read pre-stored biometric data. Then, the database engine 421 controls the memory management module 411 to read the biometric data stored in advance in the memory 401, and provides the biometric data to the biometric processor 422. At this time, the biometric data stored in advance in the memory 401 may be encrypted data. The reason for encrypting and storing the biometric data is to enhance security of the biometric data.

The biometric processor 422 provides the pre-stored encrypted biometric data provided from the database engine 421 to the biometric security processor 423, and requests the biometric security processor 423 to decode it. At this time, the method of decoding the pre-stored encrypted biometric data may be divided into two methods according to an encryption method of the pre-stored encrypted biometric data. There may be a method of storing the biometric data in the form encrypted by the encryption module 413 and a method of using a separate security method. Here, the case of using the separate security method will be described.

The case requiring the separate security may also be classified into two cases. For example, a key or data for decryption may be received from a separate memory area configured as a security area within the electronic device (one memory may be differentiated into separate areas, or different memories may be used) or a separate server or electronic device for security. The separate server or electronic device may be connected through a predetermined wired/wireless network, and a key for configuration and release of security may be received from the corresponding server or electronic device.

For convenience of description, it is assumed that one electronic device has a separate memory area. However, it is apparent to those skilled in the art that the case of receiving the key for configuration and release of security or data for security from the specific server or electronic device may be appreciated through the same method except that the data is received from another device through the wired/wireless network.

The security interface 424 may request a security medium 460 to provide a key or data for decrypting the pre-registered biometric data. Accordingly, when receiving the key or data for the decryption, the security interface 424 provides the key or data to the biometric security processor 423.

At this time, the security medium 460 may create a unique key or data for configuring/releasing security using information such as a chipset ID, and provide it to the security interface 424.

The biometric security processor 423 may decode the pre-registered encrypted biometric data using the received key or data for decryption and provide the decoded biometric data to the biometric processor 422.

Accordingly, the biometric processor 422 has first biometric data obtained by decrypting, by the biometric security processor 423, the encrypted biometric data stored in the memory 401 and second biometric data received from the biometric sensor 403 and requested to be compared with the first biometric data. The biometric processor 422 provides the first biometric data and the second biometric data to the validity service 430.

The image reconfiguration module 433 of the validity service 430 converts the second biometric data into a preconfigured size or standard of data for comparison of the two pieces of data.

The first biometric data and the standardized second biometric data are input to the feature extraction module 434. The feature extraction module 434 extracts features for biometrics from the respective data and provides the extracted features to the matching module 435. The matching module 435 compares the features of the first biometric data with those of the standardized second biometric data to determine whether the first biometric data and the standardized second biometric data match each other. Here, determining whether the first biometric data and the standardized second biometric data match each other may correspond to determining whether the two pieces of biometric data or the features thereof are identical to each other or are within a preset margin of error. The matching module 435 determines whether the two pieces of data match each other, and provide the result to the biometric processor 422 through the transmission module 431.

The validity detection manager 447 performs a function of displaying, to a user, the result transferred from the validity service 430. That is, the validity detection manager 447 performs a function of displaying messages related to errors occurring in the sensor control module 432, the image reconfiguration module 433, the feature extraction module 434, and the like, and/or a function of displaying the user authentication result determined by the matching module 435.

Next, an operation of registering biometric data will be described.

As described above, the biometric processor 422 receives the biometric data from the biometric sensor 403 through the biometric driver 414. During registration, biometric data may be requested two or more times, for example, four times. When the biometric data is requested several times as described above, if an error between the several pieces of data received is extremely small, the several pieces of data match each other and correspond to data standardized in advance through the image reconfiguration module 433. The electronic device may store all pieces of biometric data repeatedly input several times, or one piece of representative data. Hereinafter, it is assumed that one piece of representative data is stored.

The biometric processor 422 decodes, through the biometric security processor 423, the biometric data encrypted by the encryption module 413. When registration is requested, the biometric processor 422 transfers the decoded data to the biometric security processor 423, and requests the biometric security processor 423 to perform security processing on the decoded data, for example, to encrypt the decoded data.

Then, the biometric security processor 423 may request security information from the security interface 424. The security interface 424 receives security data from the security medium 460 through the security interface driver 415, and provides the received security data to the security interface 424. At this time, the security medium 460 may be the same type as that described above.

The security interface 424 receives a unique key or unique data for encryption, and provides the unique key or data to the biometric security processor 423. The biometric security processor 423 encrypts the biometric data requested to be registered using the unique key or data for encryption received from the encryption interface 424. The biometric security processor 423 provides the encrypted biometric data to the biometric processor 422.

The biometric processor 422 requests the database engine 421 to configure the encrypted biometric data as registered data, and to store it. The database engine 421 may receive the encrypted biometric data to provide it to the memory management module 411 and control the memory management module 411 to store the encrypted biometric data in the biometric registration data storage area of the memory 401.

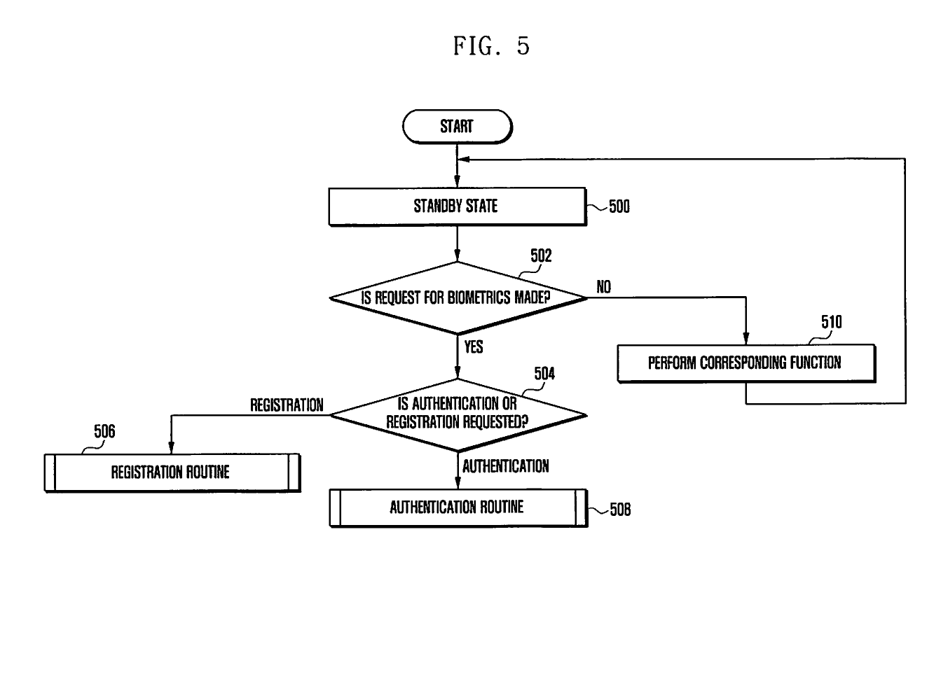

FIG. 5 is a flowchart illustrating registration and authentication operations using biometrics in an electronic device for biometrics, according to an embodiment of the present invention.

The description of FIG. 5 is provided with reference to the block diagrams of FIGS. 2 and 4. However, when the configurations of FIG. 1 are used, the user input module 140 may include the sensor module 240 of FIG. 2, and this may help an overall operation to be identically understood. Furthermore, even when the configurations of FIG. 3 are used, the overall operation may be identically understood, and this is apparent to those skilled in the art.

The processor 210 is in a standby state, in step 500. The standby state may include a dormant state for reducing battery consumption for a mobile terminal, and may correspond to a state in which the processor 210 stands ready for a request for a specific operation or an occurrence of a specific event, for example, reception of a message, a request for a telephone call, a preconfigured alarm, a request for a preconfigured operation, and the like. When a specific event occurs, the processor 210 determines whether a request for biometrics is made, in step 502. The request for biometrics may correspond to a state in which an input is requested through the biometric sensor 403 as described above with reference to FIG. 4. Furthermore, for a mobile terminal, a case in which unlocking is requested in a locked state and the preconfigured unlocking method corresponds to biometrics may also be included.

When it is determined that the request for biometrics has not been made, the processor 210 performs a corresponding function, in step 510, before returning to the standby state, in step 500.

When it is determined that the request for biometrics has been made, the processor 210 determines whether authentication or registration is requested, in step 504. When the authentication is requested, a determination may be made as to whether unlocking is requested using the biometric method or whether authentication is required through biometrics in a particular operation. When it is determined that the authentication has been requested by a registrant, the processor proceeds to an authentication routine, in step 508. When it is determined that new registration has been requested, the processor proceeds to a registration routine, in step 506.

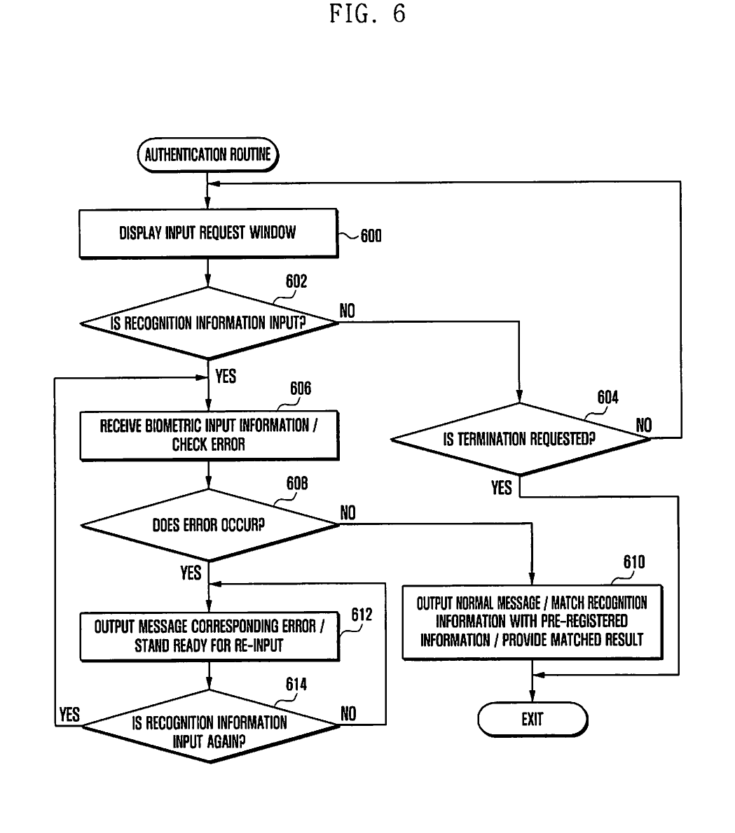

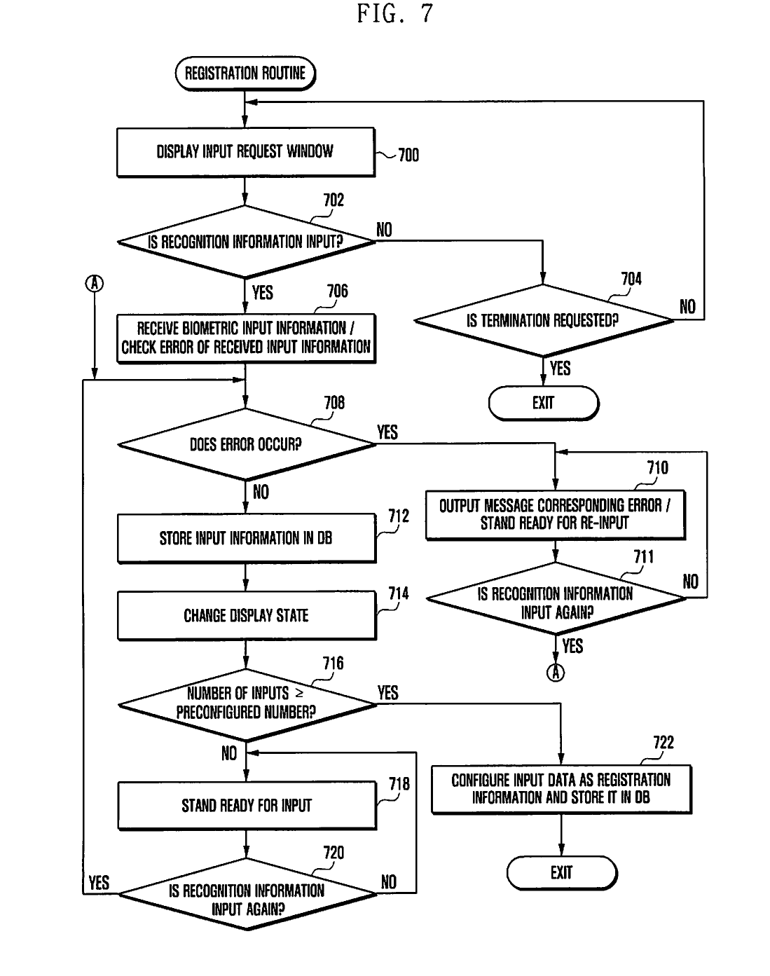

Operations 506 and 508 are described in greater detail below with reference to FIGS. 6 and 7, respectively.

FIG. 6 is a flowchart illustrating an authentication operation using biometrics in an electronic device for biometrics, according to an embodiment of the present invention. In describing the flowchart of FIG. 6, the description will be given with reference to separate drawings, and fingerprint recognition, which is a representative biometric method, will be described as an example in the separate drawings. However, various other biometric methods such as iris recognition, vein recognition, ear recognition, and the like may be employed in the same form. In these cases, a biometric sensor may be replaced by another type of sensor such as, for example, a camera or a special camera.

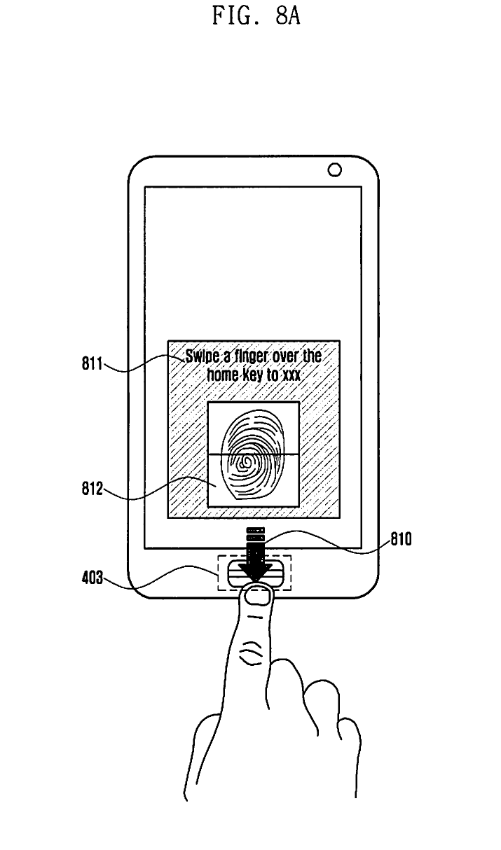

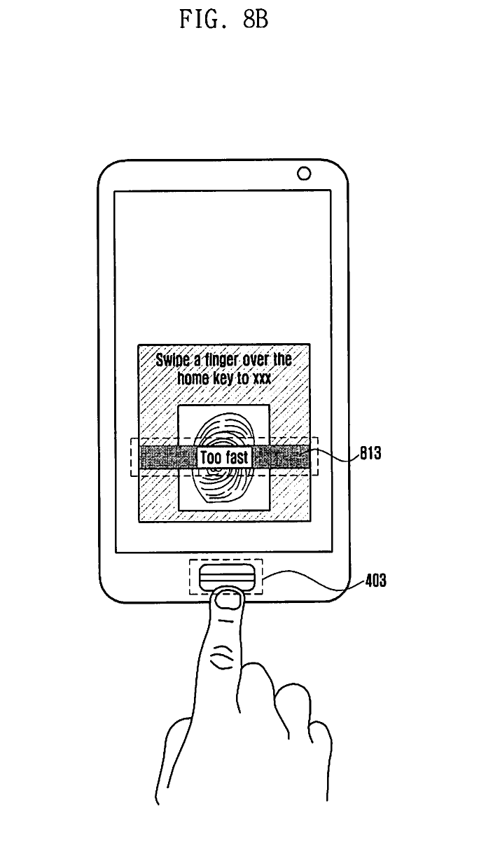

In step 600, the processor 210 displays an input request window on the display module 260. In step 602, the processor 210 determines whether recognition information is input from the biometric sensor 240I of the sensor module 240. The input request window displayed on the display module 260, and the operation in which the recognition information is input are described in greater detail with reference to FIGS. 8A and 8B.

FIGS. 8A and 8B illustrate a general input request window for biometric information in an electronic device.

Referring to FIG. 8A, a user inputs biometric information through the biometric sensor 403. At this time, the user inputs a fingerprint by swiping a finger over the biometric sensor 403 in the form indicated by reference numeral 810.

In FIG. 8A, an input request window for requesting a fingerprint input is displayed as indicated by reference numeral 811. Furthermore, when displaying a fingerprint on the display module 260 as indicated by reference numeral 812, the processor 210 may display the acquired fingerprint after the fingerprint is completely input, display an arbitrary form of the fingerprint before the fingerprint is acquired, or display a fingerprint registered by a user. Hereinafter, it is assumed that the user swipes a finger over the biometric sensor 403 in the form indicated by reference numeral 810 and then, the biometric information acquired by the biometric sensor 403 is displayed.

FIG. 8B illustrates an example in which a user swipes a finger over the biometric sensor 403 so fast that an error message is displayed. As illustrated in FIG. 8B, in simply instructing the user's action, a general electronic device displays the input error of the user only in the text form as indicated by reference numeral 813. Display methods, according to various embodiments of the present invention, are described in greater detail below.

Referring back to FIG. 6, when it is determined in step 602 that the recognition information has not been input, the processor 210 determines whether termination is requested, in step 604. When it is determined that the termination has been requested, the processor 210 terminates the routine of FIG. 6. In contrast, when it is determined that the termination has not been requested, the processor 210 returns to step 600 to maintain the input request window displayed.

When it is determined in step 602 that the recognition information has not been input and it is determined in step 604 that the termination has not been requested, even though there is an input, the processor 210 may ignore the input. Furthermore, when it is determined in step 602 that the recognition information has not been input and it is determined in step 604 that the termination has not been requested, there may not be an input.

When it is determined in step 602 that the recognition information has been input, the processor 210 receives the biometric information from the biometric sensor 403 and checks for an error in the received input information, in step 606. At this time, the received input information may be input information processed in the form normalized by the image reconfiguration module 433 as described above with reference to FIG. 4.

The error of the biometric input information is set forth in Table 1 below.

TABLE 1

| Quality Flag | Image quality Rags | Detail Information (values when available) | Improvement |
|---|---|---|---|
| 0x00000002 | VCS_IMAGE_QUALITY_TOO_FAST | Fast swipe on quality is reported for swipes greater | User to swipe slower on the sensor |
| | | than 30 cm/s | |
| 0x00000004 | VCS_IMAGE_QUALITY_TOO_SHORT | User swiped without the whole length of finger, | Please keep the finger flat when swiping, |
| | | the most common case for this is the case when | and swipe whole length of the finger from |
| | | the user swipes the tip of the finger. Height | knuckle until tip. |
| | | is less than 168 pixels. | |
| 0x00000010 | VCS_IMAGE_QUALITY_TOO_SLOW | Slow swipes on quality is reported for slow swipes | User to swipe faster on the sensor |
| 0x00001000 | VCS_IMAGE_QUALITY_FINGER_ | finger is too far left or right of center. Offset to | Please swipe your finger smoothly across |
| | OFFSET | the left or right is greater than width/5 (115/ | the middle of the sensor with gentle |
| | | 5 = 23 for the 46A sensor) | pressure |
| 0x00080000 | VCS_IMAGE_QUALITY_PRESSURE_ | Too much pressure was applied when swiping | Please swipe your finger smoothly across |
| | TOO_HARD | the finger on the sensor | the middle of the sensor with a little less |
| | | | pressure |
| 0x00200000 | VCS_IMAGE_QUALITY_NOT_A_ | it does not appear that the user actually swiped | Finger swipe not recognized. Please swipe |
| | FINGER_SWIPE | a finger after touching the sensor | your finger smoothly across the middle |
| | | | of the sensor with gentle pressure |
| 0x00400000 | VCS_IMAGE_QUALITY_BASELINE_ | the finger may have been on the sensor prior | Please check if your sensor is dirty, and |
| | DATA_INVALID | to when the user was asked to swipe. Or, the | clean it |
| | | sensor may not be property calibrated or may be | |
| | | damaged | |
| 0x01000000 | VCS_IMAGE_QUALITY_WET_FINGER | The finger was very wet | Please dry your finger and the sensor |
| | | | before swiping your finger across the sensor |
| | | | with gentle pressure |
| 0x02000000 | VCS_IMAGE_QUALITY_FINGER_TOO_ | The finger appears to be centered properly but | Please keep finger flat while swiping and |
| | THIN | is too thin, perhaps because finger is sideways, | apply a little more pressure. |
| | | or not enough pressure was applied when | |
| | | swiping. Left and right offset combined is greater | |
| | | than 86 pixels for a 115 pixels sensor width. | |
| 0x00000001 | VCS_IMAGE_QUALITY_STICTION | The finger stuck to the sensor (stiction) during | Please swipe your finger smoothly across |
| | | the swipe, or the swipe was stopped and started | the middle sensor with gentle pressure |
| | | or was not smooth enough | |

An error of a user input to the biometric sensor 403 may be diverse, as illustrated in Table 1. The quality flags in Table 1 may have different values. Furthermore, the image quality flags in the biometric sensor are particular embodiments of the present invention, and two or more image quality flags may be represented as one image quality flag, or one image quality flag illustrated in Table 1 may be two or more image quality flags.

The image quality flags of Table 1 are described in greater detail below.

Flag VCS_IMAGE_QUALITY_TOO_FAST corresponds to a case in which a user swipes a finger over the biometric sensor 403 so fast that the biometric sensor 403 cannot acquire enough data.

Flag VCS_IMAGE_QUALITY_TOO_SHORT corresponds to a case in which a user swipes a finger over the biometric sensor 403 for a very short period of time so that the biometric sensor 403 cannot acquire enough data.

Flag VCS_IMAGE_QUALITY_TOO_SLOW corresponds to a case in which a user swipes a finger over the biometric sensor 403 so slow that the biometric sensor 403 cannot acquire enough data.

Flag VCS_IMAGE_QUALITY_FINGER_OFFSET corresponds to a case in which a user swipes a finger over the biometric sensor 403 while the finger is leaning too much toward a left or right side of the biometric sensor 403 so that the biometric sensor 403 cannot acquire enough data.

Flag VCS_IMAGE_QUALITY_PRESSURE_TOO_HARD corresponds to a case in which a user swipes a finger over the biometric sensor 403 while contacting the finger with the biometric sensor 403 too hard and thus, a fingerprint is distorted or there seems to be no fingerprint so that the biometric sensor 403 cannot acquire enough data.

Flag VCS_IMAGE_QUALITY_NOT_A_FINGER_SWIPE corresponds to a case in which a user does not swipe a finger over the biometric sensor 403 within a predetermined time interval or swipes the finger over the biometric sensor 403 after the predetermined time interval so that the biometric sensor 403 cannot acquire enough data.

Flag VCS_IMAGE_QUALITY_BASELINE_DATA_INVALID corresponds to a case in which a user swipes a finger over the biometric sensor 403 before the biometric sensor 403 is ready for acquiring biometric data, or the biometric sensor 403 does not normally operate or acquire an accurate value.

Flag VCS_IMAGE_QUALITY_WET_FINGER corresponds to a case in which a user swipes a wet finger over the biometric sensor 403 so fast that the biometric sensor 403 cannot acquire enough data.

Flag VCS_IMAGE_QUALITY_FINGER_TOO_THIN corresponds to a case in which a user swipes a finger over a very narrow range of the biometric sensor 403 as if the finger grazes the biometric sensor 403 so that the biometric sensor 403 acquires only very thin or narrow data.

Flag VCS_IMAGE_QUALITY_STICTION corresponds to a case in which a user discontinues swiping a finger over the biometric sensor 403 or swipes the finger over the biometric sensor 403 too softly or lightly, so that the biometric sensor 403 acquires only very thin or narrow data.

In step 606, the processor 210 checks whether the aforementioned types of biometric input errors occur. In step 608, the processor 210 determines whether an error occurs.

When it is determined that an error has not occurred, the processor 210 outputs a normal input message, matches the normally input biometric information with the previously registered biometric information, and provides the matched result, in step 610. The processor 210 then terminates the routine of FIG. 6. At this time, the corresponding operation may be approved or rejected according to the matched result. When the operation requested by the routine of FIG. 6 is approved, the corresponding operation is performed. For example, when unlocking is requested, locking is released. In contrast, when the operation requested by the routine of FIG. 6 is not approved, the corresponding operation is rejected. For example, when unlocking is requested, the unlocking is rejected.

When it is determined that an error has occurred in step 608, the processor 210 outputs a message corresponding to the error, and stands ready for an input of recognition information, in step 612. In operation 614, the processor 210 determines whether the recognition information is input through the biometric sensor 403 again. When it is determined that the recognition information has been input again, the processor 210 returns to step 606. When it is determined that the recognition information has not been input, the processor 210 returns to step 612.

Outputting messages corresponding to respective errors occurring, according to various embodiments of the present invention, are described in greater detail below.

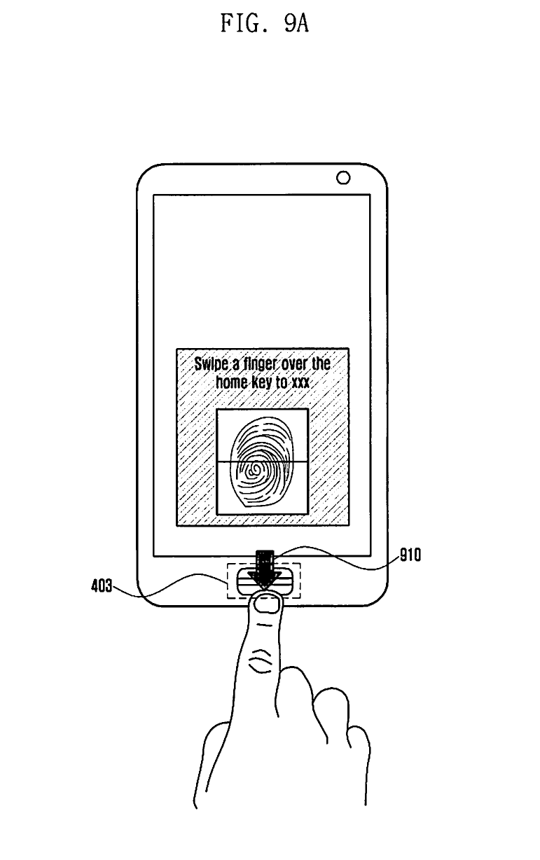

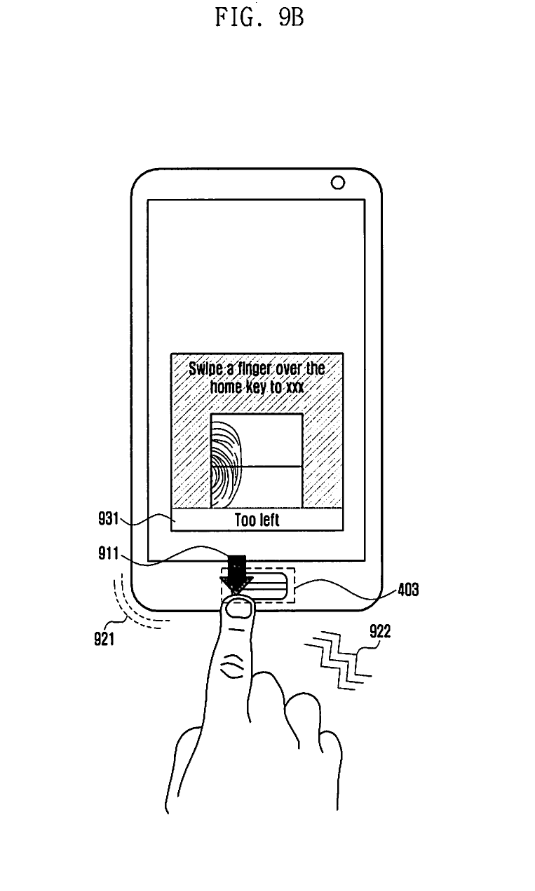

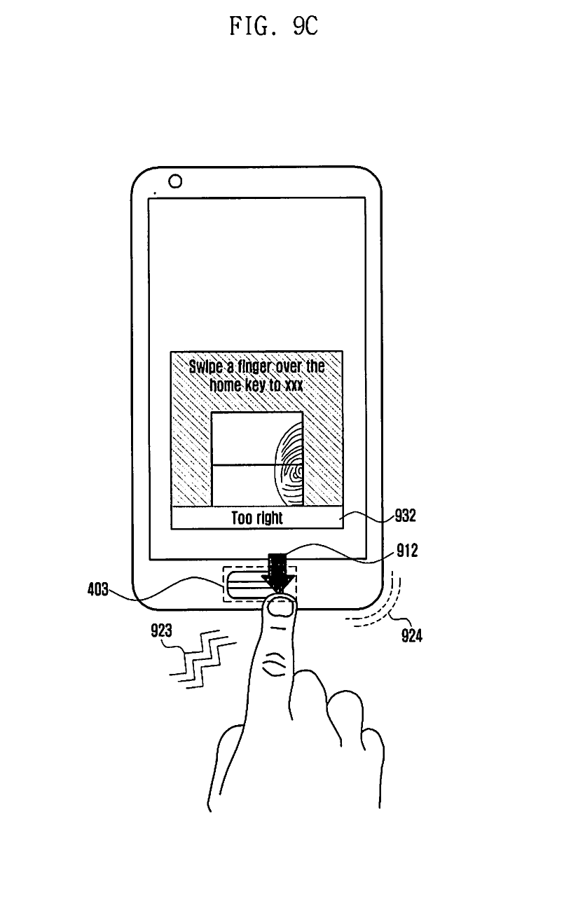

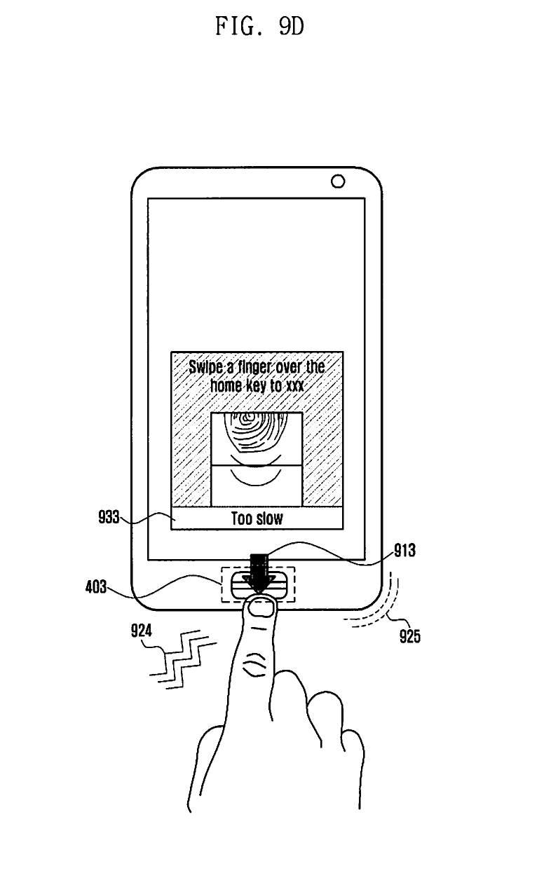

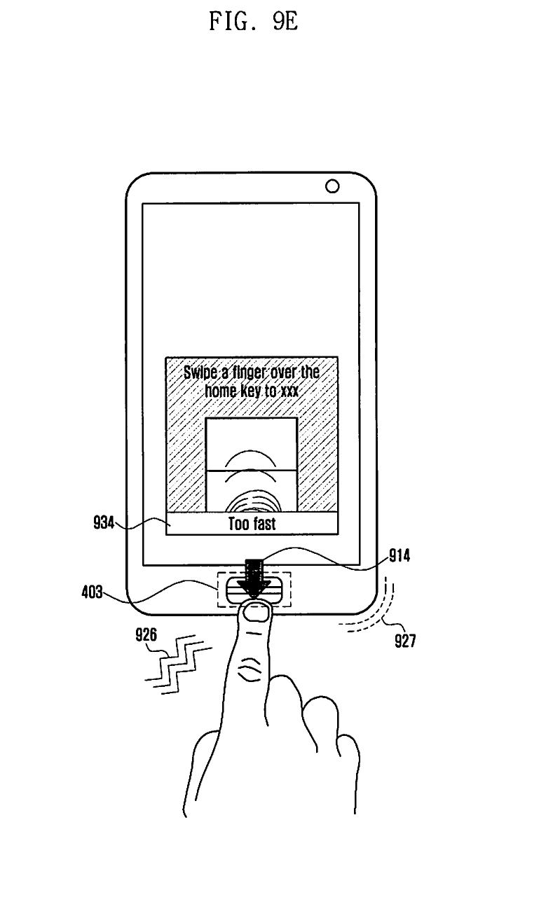

FIGS. 9A to 9D illustrate message output in response to a normal operation and an error of biometrics in an electronic device performing the biometrics, according to an embodiment of the present invention.

Referring to FIG. 9A, when a user swipes a finger over the biometric sensor 403 as indicated by reference numeral 910, the biometric sensor 403 acquires fingerprint information, as described above with reference to FIG. 4. Furthermore, as described above with reference to FIG. 6, when biometrics are required in response to a request for unlocking or a particular operation, a check may be carried out by comparing the acquired biometric information with the pre-registered biometric information.

FIGS. 9B to 9E illustrate a user's input error and an operation performed by an electronic device in response to the input error.

Referring to FIG. 9B, when a user swipes a finger over the biometric sensor 403 while the finger is leaning toward a left side of the biometric sensor 403, as indicated by reference numeral 911, the biometric sensor 403 does not acquire enough biometric data. In response to such a swipe operation, an error message is displayed in text form on the display module 260, as indicated by reference numeral 931. Furthermore, in order to notify of the error, the electronic device controls the motor 298 to output vibration to a left part of the electronic device corresponding to the direction toward which the finger leans, as indicated by reference numeral 921. It is assumed that the electronic device, according to an embodiment of the present invention, provides a vibration by differentiating at least two or more of a left side, a right side, a top side, and a bottom side thereof. Moreover, as indicated by reference numeral 922, the electronic device controls the speaker 282 to output an alarm sound. It is assumed that the speaker 282 may also output an alarm sound by differentiating at least two or more of the left side, the right side, the top side, and the bottom side of the electronic device. When the speaker 282 is configured with one speaker, the speaker 282 may also output a voice message “You have input the fingerprint, leaning too much toward the left”. In addition, the acquired fingerprint leaning toward the left may also be displayed in a fingerprint display area where a fingerprint is displayed on the display module 260.

Referring to FIG. 9C, when a user swipes a finger over the biometric sensor 403 while the finger is leaning toward a right side of the biometric sensor 403, as indicated by reference numeral 912, the biometric sensor 403 does not acquire enough biometric data. In response to such a swipe operation, an error message is displayed in text form on the display module 260, as indicated by reference numeral 932. Furthermore, in order to notify of the error, the electronic device controls the motor 298 to output a vibration to a right part of the electronic device corresponding to the direction toward which the finger leans, as indicated by reference numeral 924. Moreover, as indicated by reference numeral 923, the electronic device controls the speaker 282 to output an alarm sound. It is assumed that the speaker 282 may also output an alarm sound by differentiating at least two or more of the left side, the right side, the top side, and the bottom side of the electronic device. When the speaker 282 is configured with one speaker, the speaker 282 may also output a voice message “You have input the fingerprint, leaning too much toward the right”. In addition, the acquired fingerprint leaning toward the right may also be displayed in a fingerprint display area where a fingerprint is displayed on the display module 260.

Referring to FIG. 9D, when a user swipes a finger over the biometric sensor 403 too slowly, as indicated by reference numeral 913, the user's input speed is so low that the biometric sensor 403 does not acquire enough or accurate biometric data. In response to such a swipe operation, an error message is displayed in text form on the display module 260, as indicated by reference numeral 933. Furthermore, in order to notify of the error, the electronic device controls the motor 298 to output a vibration in a form through which the user is notified of the low input speed, for example, in a form indicated by reference numeral 925. Moreover, as indicated by reference numeral 924, the electronic device controls the speaker 282 to output an alarm sound so as to notify the user that the input speed of the user is too low. It is assumed that the speaker 282 may also output an alarm sound by differentiating at least two or more of the left side, the right side, the top side, and the bottom side of the electronic device. When the speaker 282 is configured with one speaker, the speaker 282 may also output a voice message “Swiping is too slow” or “Please, input a fingerprint a little faster”. In addition, only the final shape of the fingerprint as illustrated in FIG. 9D may also be displayed in a fingerprint display area where a fingerprint is displayed on the display module 260.

Referring to FIG. 9E, when a user swipes a finger over the biometric sensor 403 too fast, as indicated by reference numeral 914, the user's input speed is so high that the biometric sensor 403 does not acquire enough biometric data. In response to such a swipe operation, an error message is displayed in text form on the display module 260, as indicated by reference numeral 934. Furthermore, in order to notify of the error, the electronic device controls the motor 298 to output a vibration in a form through which the user is notified of the high input speed, for example, in a form indicated by reference numeral 927. Moreover, as indicated by reference numeral 926, the electronic device controls the speaker 282 to output an alarm sound so as to notify the user that the input speed of the user is too high. It is assumed that the speaker 282 may also output an alarm sound by differentiating at least two or more of the left side, the right side, the top side, and the bottom side of the electronic device. When the speaker 282 is configured with one speaker, the speaker 282 may also output a voice message “Swiping is too fast” or “Please, input a fingerprint more slowly”. In addition, only the first shape of the fingerprint as illustrated in FIG. 9E may also be displayed in a fingerprint display area where a fingerprint is displayed on the display module 260.

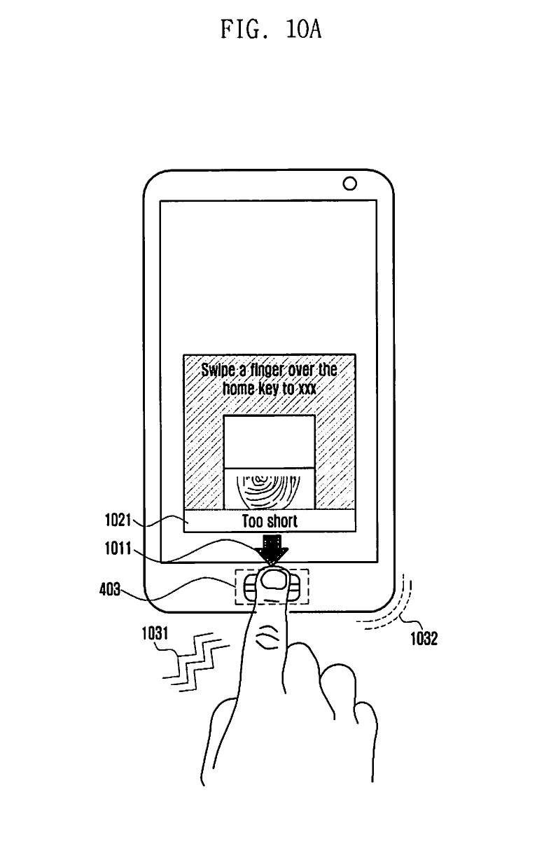

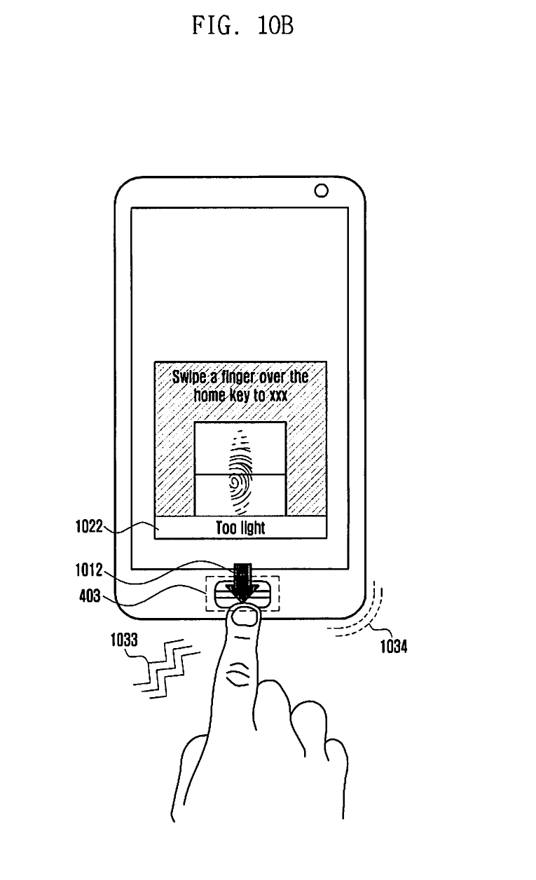

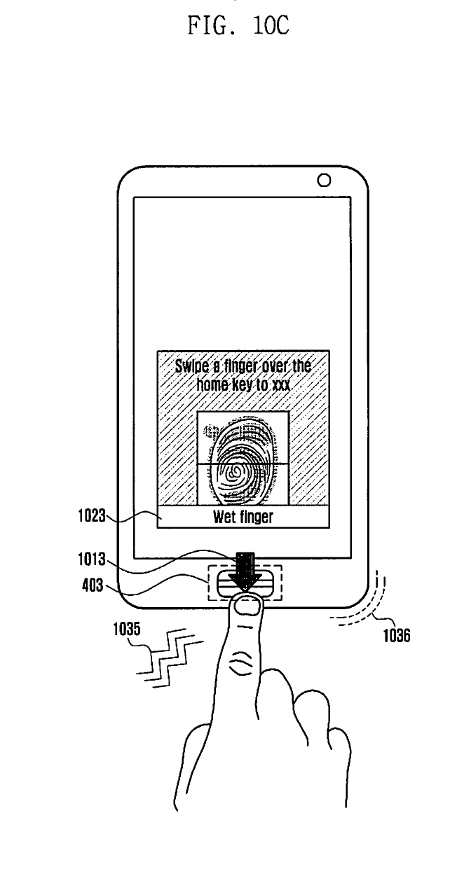

Errors different from those described above are described with reference to FIGS. 10A to 10C.

FIGS. 10A to 10C illustrate message output in response to an error of biometrics in an electronic device performing the biometrics, according to an embodiment of the present invention.

Referring to FIG. 10A, when a user swipes a finger over the biometric sensor 403 for a very short period of time, as indicated by reference numeral 1011, the biometric sensor 403 does not acquire enough biometric data to recognize the user's fingerprint. In response to such an erroneous swipe operation, an error message is displayed in text form on the display module 260, as indicated by reference numeral 1021. Furthermore, in order to notify of the error, the electronic device controls the motor 298 to output a vibration in a form through which the user is notified of the short input time, for example, in a form indicated by reference numeral 1032. Moreover, as indicated by reference numeral 1031, the electronic device controls the speaker 282 to notify the user, through an output of an alarm sound, that the input time is too short. It is assumed that the speaker 282 may also output an alarm sound by differentiating at least two or more of the left side, the right side, the top side, and the bottom side of the electronic device. When the speaker 282 is configured with one speaker, the speaker 282 may also output a voice message “Swiping time is too short” or “Please, swipe an entire finger over the biometric sensor”. In addition, only the first shape of the fingerprint, as illustrated in FIG. 10A, is displayed in a fingerprint display area where a fingerprint is displayed on the display module 260.

Referring to FIG. 10B, when a user swipes a finger over the biometric sensor 403 too lightly (in a state in which the finger does not sufficiently contact the biometric sensor), as indicated by reference numeral 1012, the biometric sensor 403 does not acquire enough biometric data to recognize the user's fingerprint. In response to such an erroneous swipe operation, an error message is displayed in text form on the display module 260, as indicated by reference numeral 1022. Furthermore, in order to notify of the error, the electronic device controls the motor 298 to output vibration in a form through which the user is notified of the insufficient input, for example, in a form indicated by reference numeral 1034. Moreover, as indicated by reference numeral 1033, the electronic device controls the speaker 282 to notify the user, through an output of an alarm sound, that the user input is not sufficient. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Please swipe a finger over the biometric sensor while sufficiently contacting the finger with the biometric sensor” or “Finger contact surface is too small”. In addition, only the first shape of the fingerprint as illustrated in FIG. 10B may also be displayed in a fingerprint display area where a fingerprint is displayed on the display module 260.

Referring to FIG. 10C, when a user swipes a wet finger over the biometric sensor 403, as indicated by reference numeral 1013, the biometric sensor 403 does not acquire the fingerprint or enough biometric data required for authentication due to moisture on the finger. In response to such an erroneous input, an error message is displayed in text form on the display module 260, as indicated by reference numeral 1023. Furthermore, in order to notify of the error, the electronic device controls the motor 298 to output vibration in a form through which the user is notified that the finger is wet, for example, in a form indicated by reference numeral 1036. Moreover, as indicated by reference numeral 1035, the electronic device controls the speaker 282 to notify the user, through an output of an alarm sound, that the user's finger is wet. It is assumed that the speaker 282 may output an alarm sound by differentiating at least two or more of the left side, the right side, the top side, and the bottom side of the electronic device. When the speaker 282 is configured with one speaker, or when it is difficult to indicate the input through the wet finger, the speaker 282 may also output a voice message “Finger is wet” or “Input after removing moisture from the finger”. In addition, only the first shape of the fingerprint as illustrated in FIG. 10C may also be displayed in a fingerprint display area where a fingerprint is displayed on the display module 260.

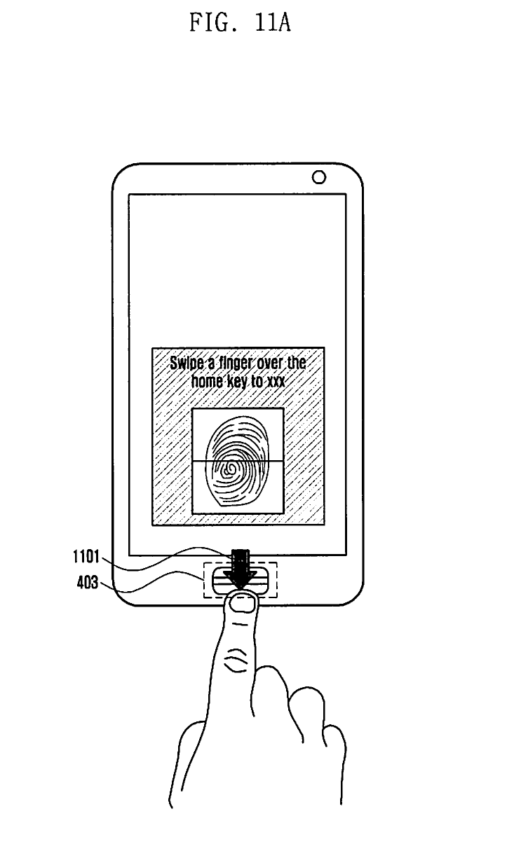

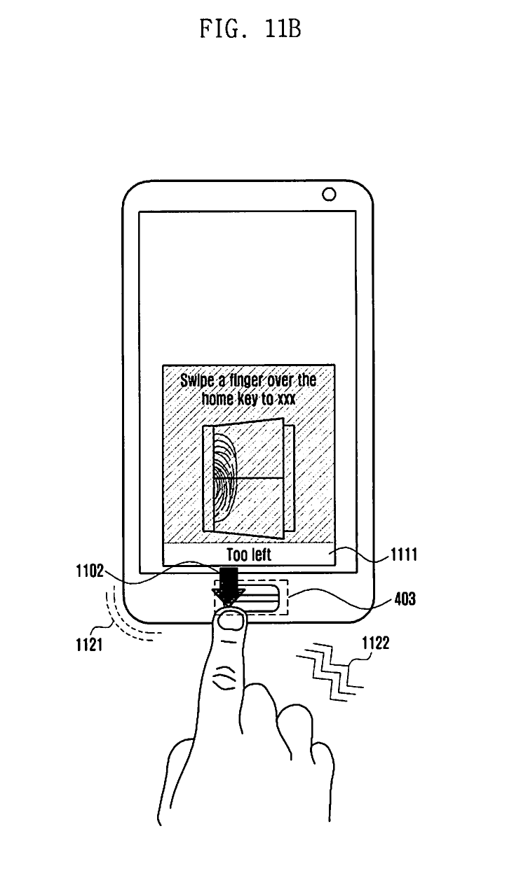

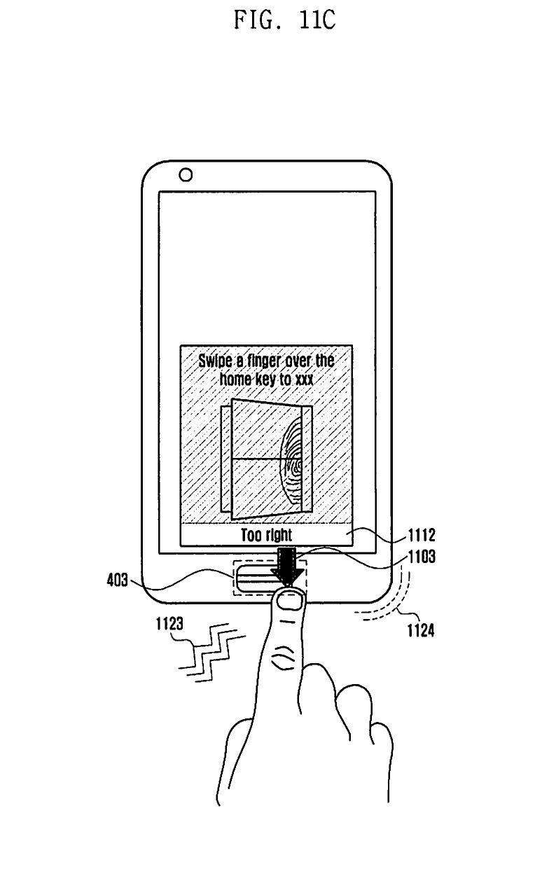

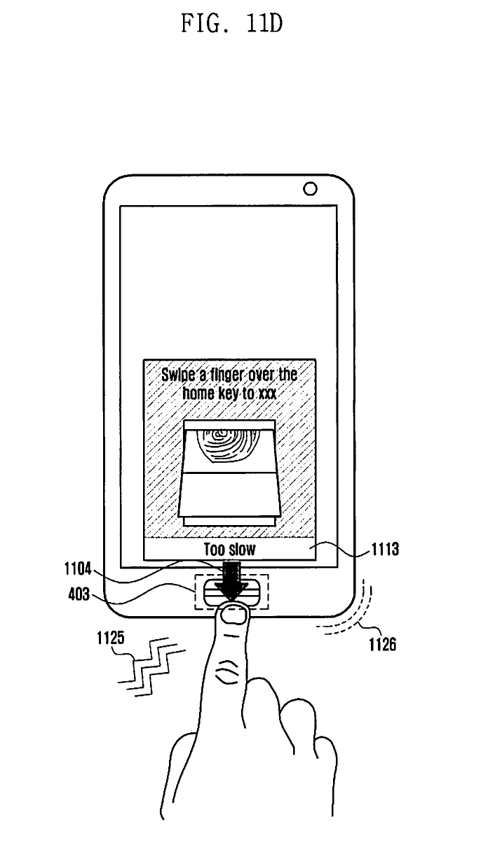

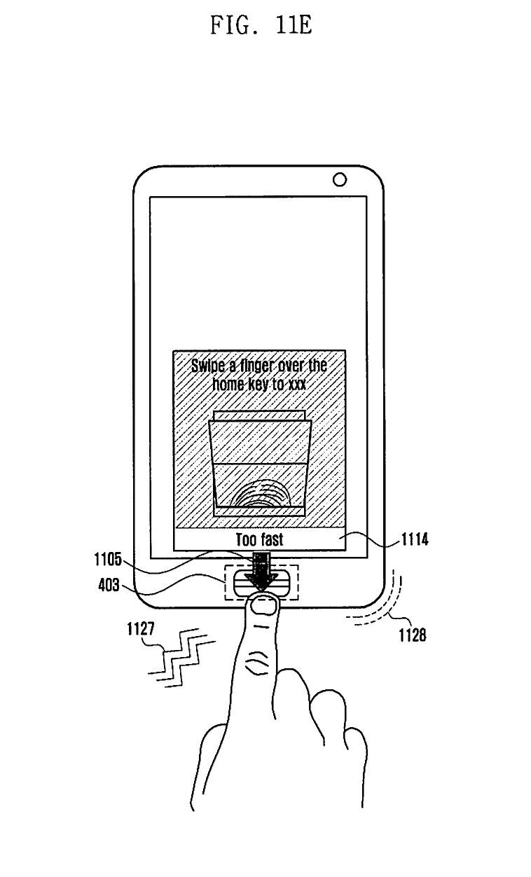

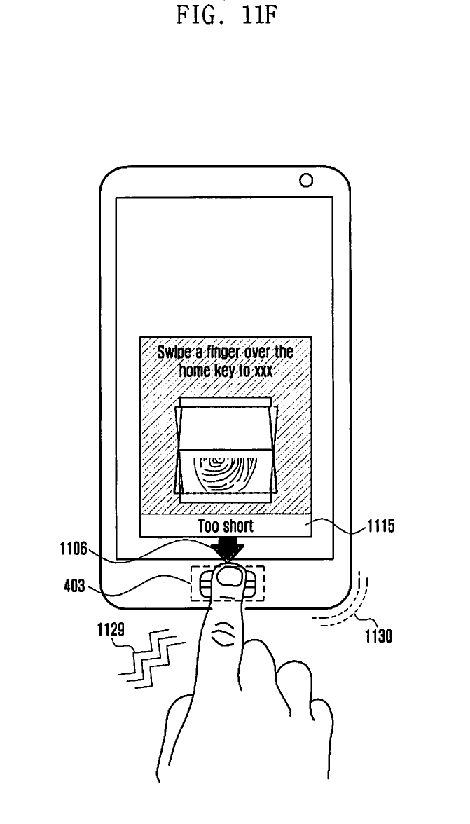

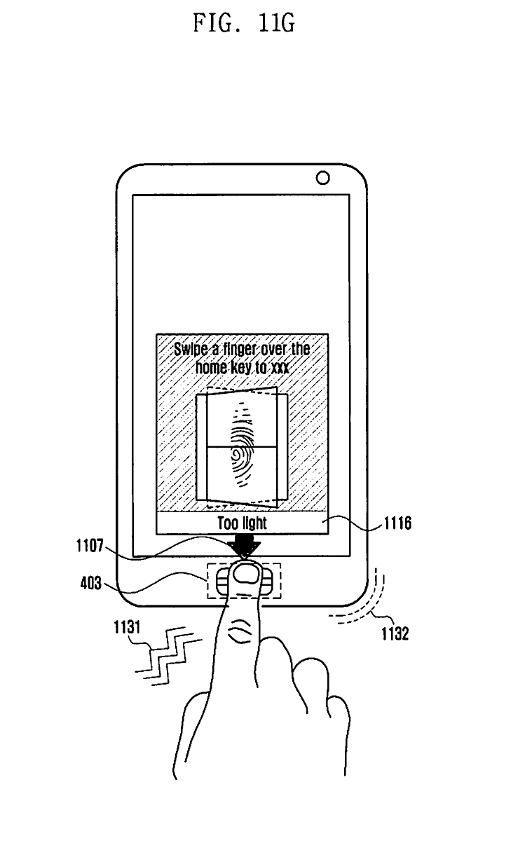

FIGS. 11A to 11G illustrate message output in response to a normal input and an erroneous input of biometrics in an electronic device performing the biometrics, according to an embodiment of the present invention.

Referring to FIG. 11A, when a user normally swipes a finger over the biometric sensor 403, as indicated by reference numeral 1101, the biometric sensor 403 normally recognizes the user's fingerprint. At this time, the biometric sensor 403 acquires fingerprint information as described above with reference to FIG. 4. The acquired fingerprint data is normally displayed at a fingerprint input location of the display module 260. Furthermore, as described above with reference to FIG. 6, when biometrics are required in response to a request for unlocking or a particular operation, a check is carried out by comparing the acquired biometric information with the pre-registered biometric information, and the acquired biometric information is approved or rejected according to the check result.

Referring to FIG. 11B, when a user swipes a finger over the biometric sensor 403 while the finger is leaning toward a left side of the biometric sensor 403 as indicated by reference numeral 1102, the biometric sensor 403 does not acquire enough biometric data to recognize a fingerprint. In response to such an erroneous swipe operation, an error message is displayed in text form on the display module 260, as indicated by reference numeral 1111. Furthermore, in order to notify of the error, the electronic device controls the motor 298 to output a vibration in a form through which the user is notified that the input has leaned toward the left, for example, in a form as indicated by reference numeral 1121. Moreover, as indicated by reference numeral 1122, the electronic device controls the speaker 282 to output an alarm sound so as to notify the user that the user input has leaned too much toward the left. Furthermore, comparing FIG. 9B with FIG. 11B, a fingerprint display window itself is also displayed to be tilted to the left in three dimensions on the display module 260, such that the user may intuitively recognize that the user input has been entered while leaning too much toward the left. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Fingerprint has been input too much toward the left” or “Please swipe a finger over the center of the biometric sensor”. In addition, the acquired fingerprint leaning toward the left may also be displayed in a fingerprint display area where a fingerprint is displayed on the display module 260.

Referring to FIG. 11C, when a user swipes a finger over the biometric sensor 403 while the finger is leaning toward a right side of the biometric sensor 403, as indicated by reference numeral 1103, the biometric sensor 403 does not acquire enough biometric data to recognize a fingerprint. In response to such an erroneous swipe operation, an error message is displayed in text form on the display module 260, as indicated by reference numeral 1112. Furthermore, in order to notify of the error, the electronic device controls the motor 298 to output a vibration in a form through which the user is notified that the input has leaned toward the right, for example, in a form indicated by reference numeral 1124. Moreover, as indicated by reference numeral 1123, the electronic device controls the speaker 282 to output an alarm sound so as to notify the user that the user input has leaned too much toward the right. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Fingerprint has been input too much toward the right” or “Please swipe a finger over the center of the biometric sensor”. In addition, the acquired fingerprint leaning to the right may also be displayed in a fingerprint display area where a fingerprint is displayed on the display module 260. Furthermore, comparing FIG. 9C with FIG. 11C, a fingerprint display window itself is also displayed to be tilted to the right in three dimensions on the display module 260, such that the user may intuitively recognize that the user input has been entered while leaning too much toward the right.

Referring to FIG. 11D, when a user swipes a finger over the biometric sensor 403 too slowly, as indicated by reference numeral 1104, the user's input speed is so low that the biometric sensor 403 does not acquire enough or accurate biometric data. In response to such a swipe operation, an error message is displayed in text form on the display module 260, as indicated by reference numeral 1113. Furthermore, in order to notify of the error, the electronic device controls the motor 298 to output a vibration in a form through which the user is notified of the low input speed, for example, in a form indicated by reference numeral 1126. Moreover, as indicated by reference numeral 1125, the electronic device controls the speaker 282 to output an alarm sound so as to notify the user that the input speed of the user is too low. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Swiping is too slow” or “Please, input the fingerprint a little faster”. In addition, the fingerprint which is not normally acquired due to the very low input speed, for example, only the final shape of the fingerprint as illustrated in FIG. 11D may also be displayed in a fingerprint display area where a fingerprint is displayed on the display module 260. Furthermore, comparing FIG. 9D with FIG. 11D, a fingerprint display window itself is also displayed to be tilted to the rear in three dimensions on the display module 260, such that the user may intuitively recognize that the user input is too slow.

Referring to FIG. 11E, when a user swipes a finger over the biometric sensor 403 too fast, as indicated by reference numeral 1105, the user's input speed is so high that the biometric sensor 403 does not acquire enough biometric data. In response to such a swipe operation, an error message is displayed in the text form on the display module 260, as indicated by reference numeral 1114. Furthermore, in order to notify of the error, the electronic device controls the motor 298 to output a vibration in a form through which the user is notified of the high input speed, for example, in a form indicated by reference numeral 1128. Moreover, as indicated by reference numeral 1127, the electronic device controls the speaker 282 to output an alarm sound so as to notify the user that the input speed of the user is too high. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Swiping is too fast” or “Please, input the fingerprint more slowly”. In addition, the fingerprint which is not normally acquired due to the very high input speed, for example, only the first shape of the fingerprint as illustrated in FIG. 11E may also be displayed in a fingerprint display area where a fingerprint is displayed on the display module 260. Furthermore, comparing FIG. 9E with FIG. 11E, a fingerprint display window itself is also displayed to be tilted to the front in three dimensions on the display module 260, such that the user may intuitively recognize that the user input is too fast.

Referring to FIG. 11F, when a user swipes a finger over the biometric sensor 403 for a very short period of time, as indicated by reference numeral 1106, the biometric sensor 403 does not acquire enough biometric data to recognize the user's fingerprint. In response to such an erroneous swipe operation, an error message is displayed in the text form on the display module 260, as indicated by reference numeral 1115. Furthermore, in order to notify of the error, the electronic device controls the motor 298 to output a vibration in a form through which the user is notified of the high input speed, for example, in a form indicated by reference numeral 1130. Moreover, as indicated by reference numeral 1129, the electronic device controls the speaker 282 to notify the user, through an output of an alarm sound, that the input time is too short. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Swiping time is too short” or “Please, swipe entire finger over biometric sensor”. In addition, the fingerprint which is not normally acquired due to the swiping for the very short time interval, for example, only the first shape of the fingerprint as illustrated in FIG. 11F may also be displayed in a fingerprint display area where a fingerprint is displayed on the display module 260. Furthermore, comparing FIG. 10A with FIG. 11F, a fingerprint display window itself is also displayed to be repeatedly tilted to the front and the rear in three dimensions on the display module 260, such that the user may intuitively recognize that the user's input time is too short.

Referring to FIG. 11G, when a user swipes a finger over the biometric sensor 403 too lightly (in a state in which the finger does not sufficiently contact the biometric sensor), as indicated by reference numeral 1107, the biometric sensor 403 does not acquire enough biometric data to recognize the user's fingerprint. In response to such an erroneous swipe operation, an error message is displayed in text form on the display module 260, as indicated by reference numeral 1116. Furthermore, in order to notify of the error, the electronic device controls the motor 298 to output a vibration in a form through which the user is notified of the insufficient input, for example, in a form indicated by reference numeral 1132. Moreover, as indicated by reference numeral 1131, the electronic device controls the speaker 282 to notify the user, through an output of an alarm sound, that the user input is not sufficient. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Please swipe a finger over biometric sensor while sufficiently contacting the finger with biometric sensor” or “Finger contact surface is too small”. In addition, the fingerprint which is not normally acquired due to the swiping for the very short time interval, for example, only the first shape of the fingerprint as illustrated in FIG. 11g may also be displayed in a fingerprint display area where a fingerprint is displayed on the display module 260. Furthermore, comparing FIG. 10B with FIG. 11G, a fingerprint display window itself is also displayed to be repeatedly tilted to the left and the right in three dimensions on the display module 260, such that the user may intuitively recognize that the user's input time is too short.

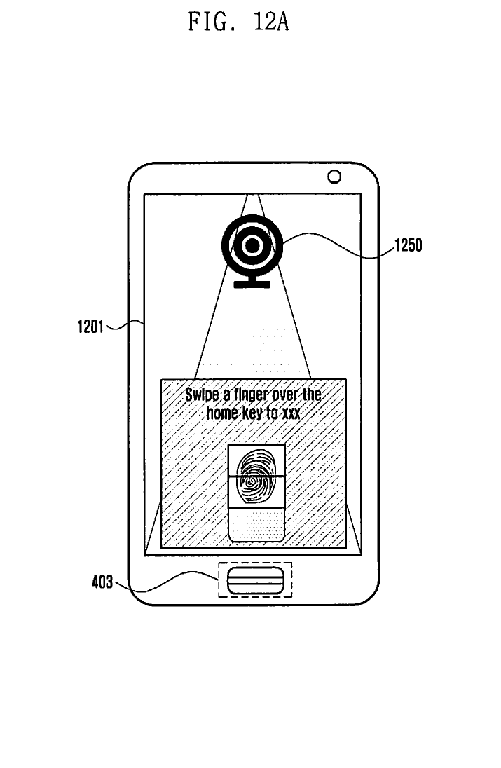

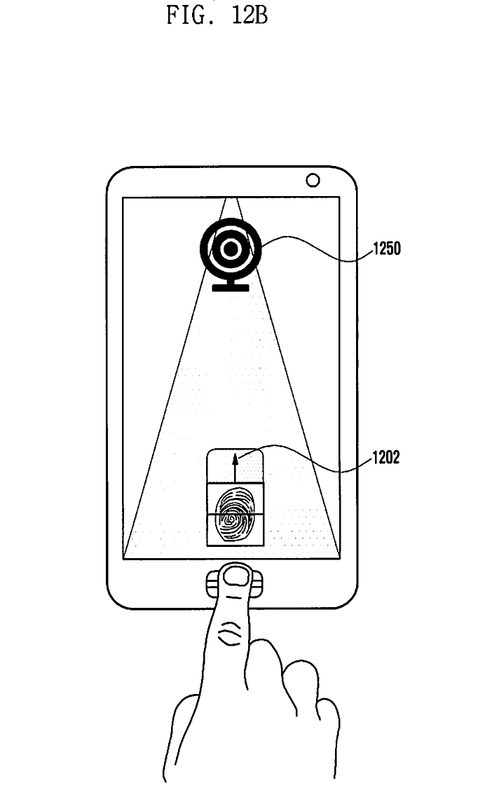

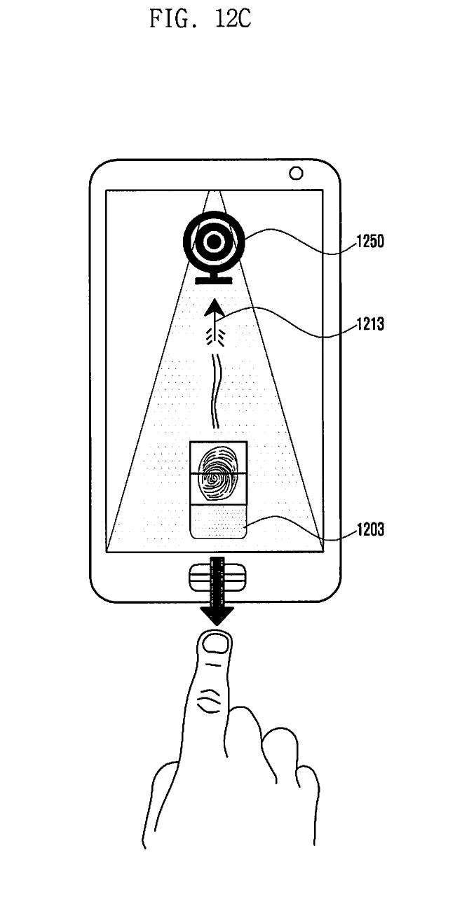

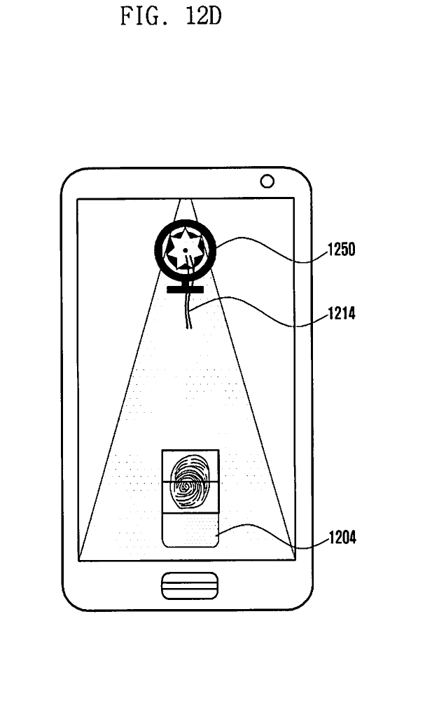

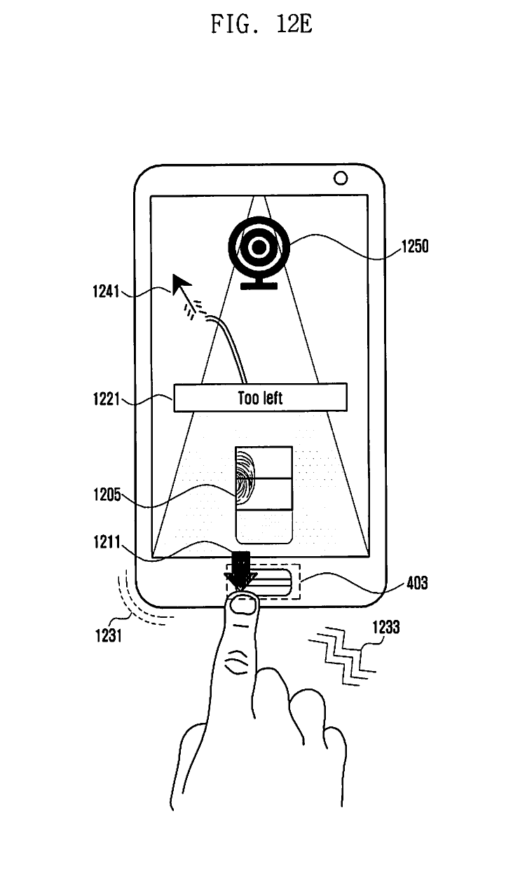

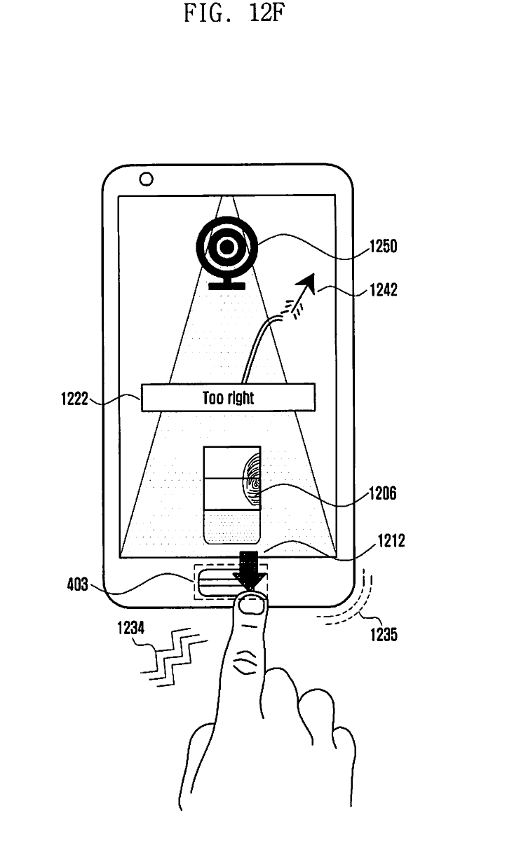

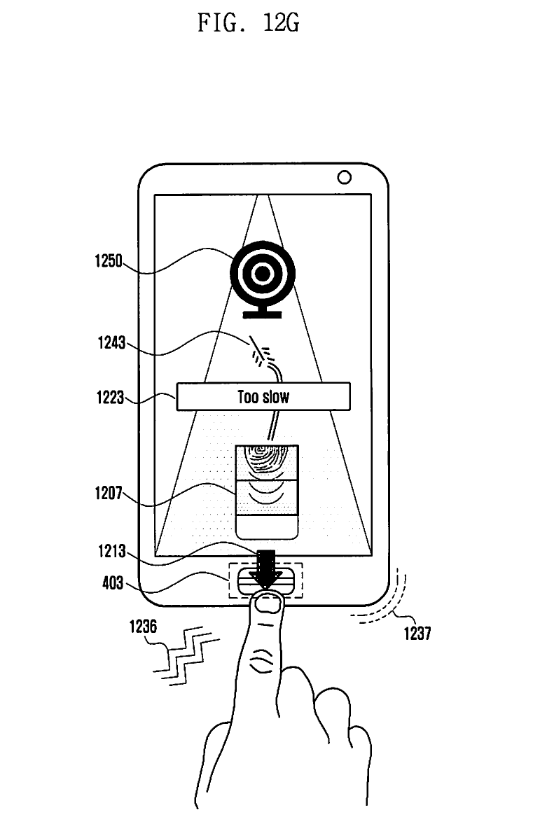

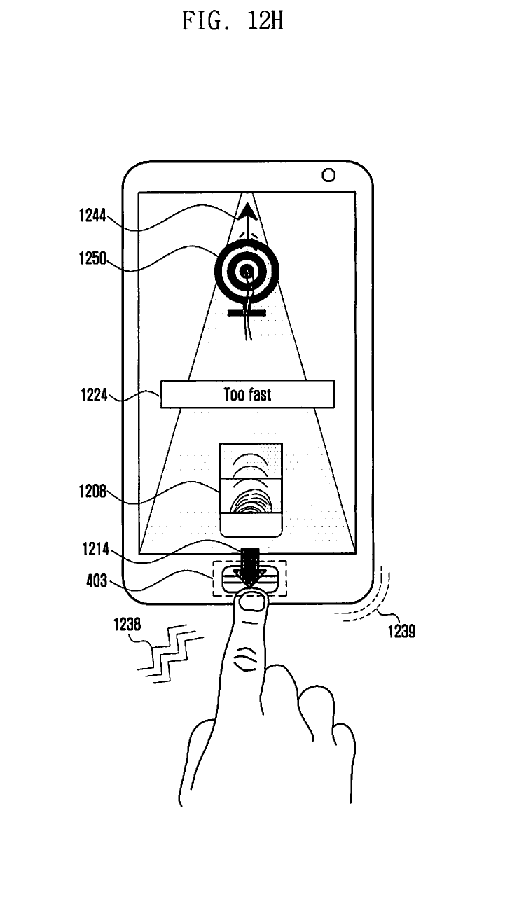

FIGS. 12A to 12H illustrate message output in response to a normal input and an erroneous input of biometrics in an electronic device performing the biometrics, according to an embodiment of the present invention.

FIG. 12A illustrates a form to be displayed in step 600 of FIG. 6. For example, the display module 260 includes a target 1250 and a display area 1201 including a fingerprint display area. Furthermore, the display module 260 displays a message for a fingerprint input together, and includes an area for displaying the fingerprint acquired as described above.

Referring to FIG. 12B, a user starts to swipe a finger over the biometric sensor. When the swiping is performed, data acquired by the biometric sensor 403 through the swiping is displayed in the fingerprint display area, and an arrow 1202 aiming at the target 1250 is displayed, such that a determination may be intuitively made as to whether the fingerprint is normally acquired.

Referring to FIG. 12C, the swiping operation is completed. When the swiping operation is completed, fingerprint data is displayed in an area 1203 for displaying the data acquired by the biometric sensor 403, for example, the fingerprint data. Furthermore, an arrow 1213 aiming at the target 1250 is displayed as if flying toward the target 1250.

Referring to FIG. 12D, when the fingerprint is normally acquired or falls into line, an arrow 1214 is displayed as if hitting the target 1250 right in the center. Furthermore, the acquired fingerprint is displayed in a fingerprint display area 1204.

As described above with reference to FIGS. 12A to 12D, when the fingerprint is normally acquired or thereafter, it is determined through fingerprint matching that the fingerprint falls into line, the screen illustrated in FIG. 12D is displayed. As illustrated in FIGS. 12A to 12D, a dynamic animation or preconfigured display data is sequentially displayed in response to the user's input to the biometric sensor 403, thereby providing enhanced security through the fingerprint input and achieving convenience, intuitiveness, and interest for the fingerprint input.

FIGS. 12E to 12H illustrate cases in which there is an error in entering the biometric input information, as described above.

Referring to FIG. 12E, when a user swipes a finger over the biometric sensor 403 while the finger is leaning toward a left side of the biometric sensor 403, as indicated by reference numeral 1211, the biometric sensor 403 does not acquire enough biometric data to recognize a fingerprint. In response to such an erroneous swipe operation, an error message is displayed in text form on the display module 260, as indicated by reference numeral 1221. Furthermore, in order to notify of the error, the electronic device controls the motor 298 to output a vibration in a form through which the user is notified that the input has leaned toward the left, for example, in a form indicated by reference numeral 1231. Moreover, as indicated by reference numeral 1233, the electronic device controls the speaker 282 to output an alarm sound so as to notify the user that the user input has leaned too much toward the left. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Fingerprint has been input too much toward the left” or “Please swipe a finger over the center of the biometric sensor”.

In addition, the acquired fingerprint leaning toward the left is also displayed in a fingerprint display area 1205 where a fingerprint is displayed on the display module 260. Furthermore, as described above, in response to the fingerprint input, an arrow 1241 aiming at the target 1250 is displayed to veer away from the target toward the left, thereby enabling the user to intuitively recognize that the user's input has been entered while leaning toward the left.

Referring to FIG. 12F, when a user swipes a finger over the biometric sensor 403 while the finger is leaning toward a right side of the biometric sensor 403, as indicated by reference numeral 1212, the biometric sensor 403 does not acquire enough biometric data to recognize a fingerprint. In response to such an erroneous swipe operation, an error message is displayed in text form on the display module 260, as indicated by reference numeral 1222. Furthermore, in order to notify of the error, the electronic device controls the motor 298 to output a vibration in a form through which the user is notified that the input has leaned toward the right, for example, in a form indicated by reference numeral 1235. Moreover, as indicated by reference numeral 1234, the electronic device controls the speaker 282 to output an alarm sound so as to notify the user that the user input has leaned too much toward the right. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Fingerprint has been input too much toward the right” or “Please swipe a finger over the center of the biometric sensor”.

In addition, the acquired fingerprint leaning toward the right is also displayed in a fingerprint display area 1206 where a fingerprint is displayed on the display module 260. Furthermore, as described above, in response to the fingerprint input, an arrow 1242 aiming at the target 1250 is displayed to veer away from the target toward the right, thereby enabling the user to intuitively recognize that the user's input has been entered while leaning toward the right.

Referring to FIG. 12G, when a user swipes a finger over the biometric sensor 403 too slowly, as indicated by reference numeral 1213, the user's input speed is so low that the biometric sensor 403 does not acquire enough or accurate biometric data. In response to such a swipe operation, an error message is displayed in text form on the display module 260, as indicated by reference numeral 1223. Furthermore, in order to notify of the error, the electronic device controls the motor 298 to output a vibration in a form through which the user is notified of the low input speed, for example, in a form indicated by reference numeral 1237. Moreover, as indicated by reference numeral 1236, the electronic device controls the speaker 282 to output an alarm sound so as to notify the user that the input speed of the user is too low. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Swiping is too slow” or “Please, input the fingerprint a little faster”.

In addition, the fingerprint acquired at the very low speed is also displayed in a fingerprint display area 1207 where a fingerprint is displayed on the display module 260. Furthermore, as described above, in response to the fingerprint input, an arrow 1243 aiming at the target 1250 is displayed not to reach the target, thereby enabling the user to intuitively recognize that the user's input is too slow.

Referring to FIG. 12H, when a user swipes a finger over the biometric sensor 403 too fast, as indicated by reference numeral 1214, the user's input speed is so high that the biometric sensor 403 does not acquire enough biometric data. In response to such a swipe operation, an error message is displayed in text form on the display module 260, as indicated by reference numeral 1224. Furthermore, in order to notify of the error, the electronic device controls the motor 298 to output a vibration in a form through which the user is notified of the high input speed, for example, in a form indicated by reference numeral 1239. Moreover, as indicated by reference numeral 1238, the electronic device controls the speaker 282 to output an alarm sound so as to notify the user that the input speed of the user is too high. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Swiping is too fast” or “Please, input the fingerprint more slowly”.

In addition, the fingerprint leaning toward the left is also displayed in a fingerprint display area 1208 where a fingerprint is displayed on the display module 260. Furthermore, as described above, in response to the fingerprint input, an arrow 1244 aiming at the target 1250 is displayed over the target, thereby enabling the user to intuitively recognize that the user's input is too fast.

FIG. 7 is a flowchart illustrating a registration operation using biometrics in an electronic device for biometrics, according to an embodiment of the present invention.

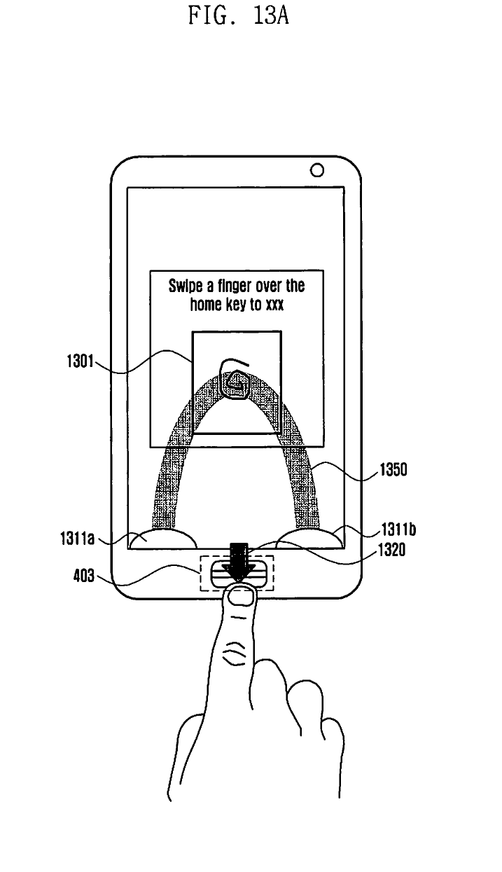

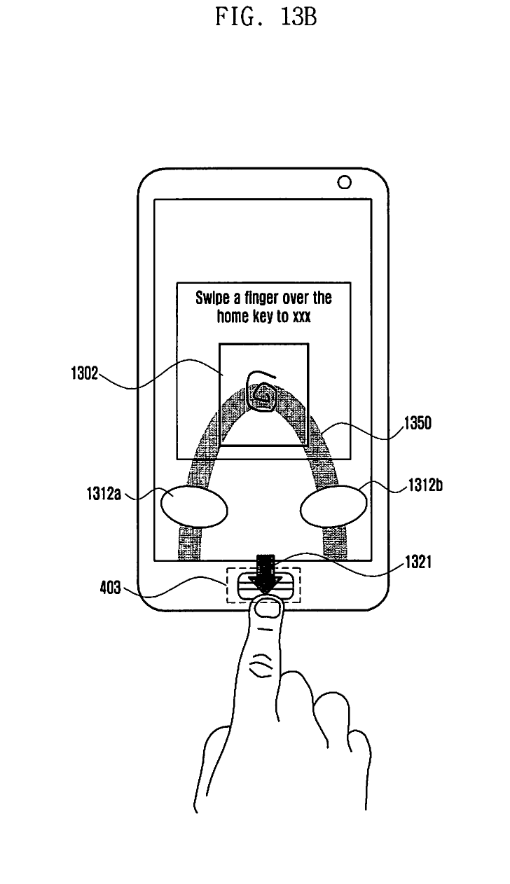

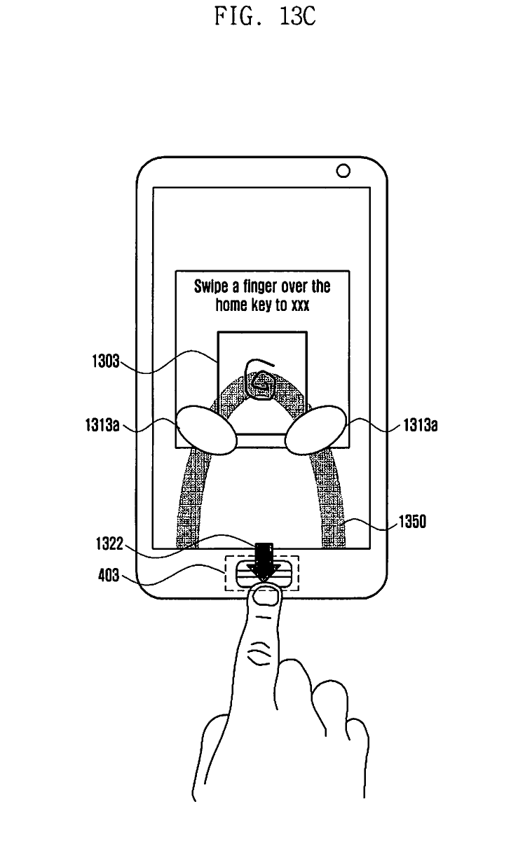

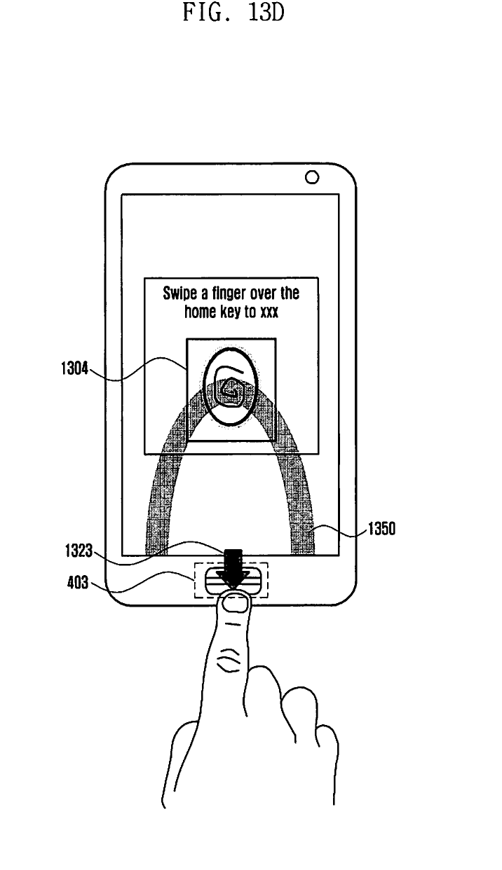

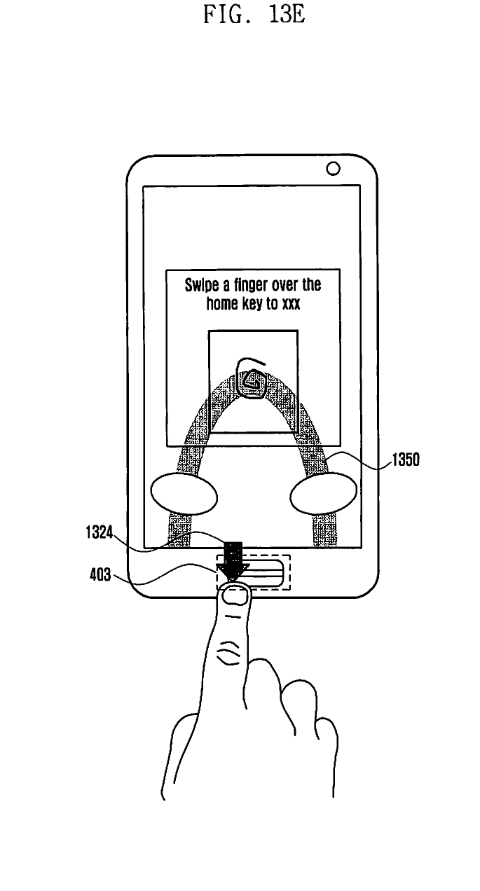

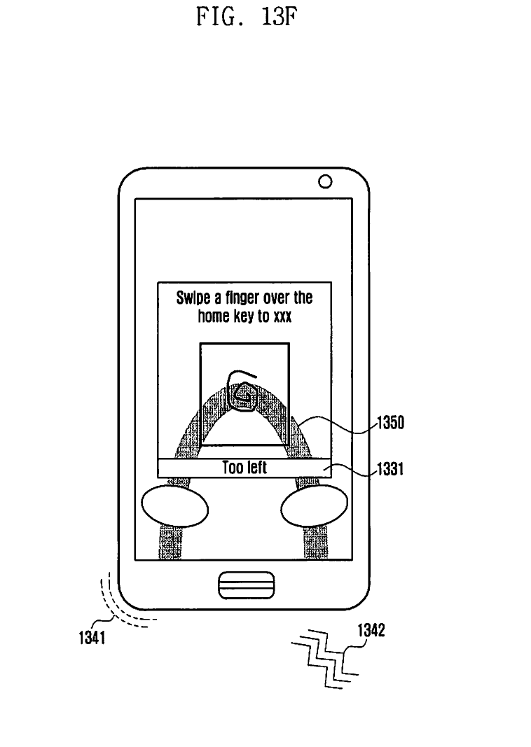

In step 700, the processor 210 displays an input request window on the display module 260. In step 702, the processor 210 determines whether recognition information is input from the biometric sensor 240I of the sensor module 240. The input request window displayed on the display module 260 in step 700, and the inputting of recognition information in step 702 are described in greater detail below with reference to FIGS. 13A to 13F.

When it is determined that the recognition information has not been input, the processor 210 determines whether termination is requested, in step 704. When it is determined that the termination has been requested, the processor 210 terminates the routine of FIG. 7. In contrast, when it is determined that the termination has not been requested, the processor 210 returns to step 700 to maintain the input request window displayed.

When it is determined that the recognition information has not been input and it is determined that the termination has not been requested, even though there is an input, the processor 210 may ignore the input. Furthermore, when it is determined that the recognition information has not been input and it is determined that the termination has not been requested, there may not be an input.

When it is determined that the recognition information has been input in step 702, the processor 210 counts the number of times the recognition information has been input, in step 706. Furthermore, in step 706, the processor 210 receives biometric input information from the biometric sensor 240I and/or the biometric sensor 403 and checks an error of the received input information. At this time, the received input information may be input information processed in a form normalized by the image reconfiguration module 433, as described above with reference to FIG. 4. Using the input information processed as described above, the processor 210 checks whether an error has occurred. The error of the biometric input information may be identical or similar to those illustrated in Table 1 above.

Thereafter, the processor 210 determines whether an error has occurred, in step 708. When it is determined that the error has occurred, the processor 210 outputs an error message on the display module 260 and stands ready for re-input, in step 710. In step 711, the processor 210 determines whether the recognition information is input again. When the recognition information is input again, the processor returns to step 708. When the recognition information is not input again, the processor returns to step 710. The message output for the error having occurred is described in greater detail below.

When it is determined that the error has not occurred in step 708, for example, when the input has been normally entered, the processor 210 temporarily stores the input information in a database, in step 712. The input information may also be stored in a predetermined buffer instead of the database, in step 712.

In step 714, the processor 210 changes a display state in response to the number of times the recognition information has been input to the display module 260. Examples of changing the display state are described in greater below.

After changing the display state of the display module 260, the processor 210 determines whether the number of inputs equals a preconfigured number, in step 716. A determination may also be made as to whether the number of inputs is greater than or equal to the preconfigured number, and the number of inputs may imply only the cases in which the inputs has been normally entered.

When the number of inputs is greater than or equal to the preconfigured number, the processor 210 configures the input data as registration information and stores it in the database, in step 722. At this time, as described above with reference to FIG. 4, the processor 210 may store all pieces of information input several times, or may select the representative biometric input data to store only the corresponding data. Furthermore, the processor 210 may also store the data as it is or encrypted using encryption data acquired through the security medium 460, as described above with reference to FIG. 4.

When it is determined that the number of inputs is less than the preconfigured number, the processor 210 stands ready for an input from the biometric sensor 240I, in step 718. At this time, the display state may be maintained on the display module 260. In step 720 it is determined whether recognition information is input again. When it is determined that the recognition information has been input from the biometric sensor 240I and/or the biometric sensor 403, the processor 210 returns to step 708. When it is determined that the recognition information has not been input, the processor 210 returns to step 718. Here, when the recognition information is input, the processor 210 may count the number of inputs of the recognition information.

FIGS. 13A to 13F illustrate message output in response to a normal input and an erroneous input when biometric information is registered in an electronic device performing the biometrics, according to an embodiment of the present invention.

FIGS. 13A to 13D illustrate a case in which an input is entered four times and the inputs are normally and continuously made, when biometric information is registered in an electronic device performing biometrics. Referring to FIGS. 13A to 13D, a guideline 1350 is illustrated for notifying of completion of a fingerprint which a user will register. The electronic device intuitively notifies the user of a state of a fingerprint input, while moving input number display windows, which can notify of the number of inputs, along the guideline 1350.

Referring to FIG. 13A, the processor 210 receives biometric information through the biometric sensor 403 illustrated in FIG. 4. At this time, a user inputs a fingerprint by swiping a finger over the biometric sensor 403, as indicated by reference numeral 1320. The operation of recognizing the fingerprint by the biometric sensor 403 has been described above with reference to FIG. 4.

In FIG. 13A, while an input request window for requesting an input of a fingerprint is being displayed, the processor 210 displays an input step indicated by reference numerals 1311a and 1311b in a predetermined area of the display module 260, in order to notify of the first input. At this time, if swiping is normally performed as indicated by reference numeral 1320, the processor 210 displays a fingerprint in the predetermined form in a fingerprint display area 1301 of the display module 260. The fingerprint displayed on the display module 260 may be some pieces of information of the fingerprint rather than the entire fingerprint. When only some pieces of the information are displayed after the first input, all pieces of information of the fingerprint data are intended to be displayed after all inputs are entered.

When the second input is received after the first input, as illustrated in FIG. 13B, in a state in which the input request window for requesting an input of a fingerprint is being displayed, the processor 210 displays an input step indicated by reference numerals 1312a and 1312b in a predetermined area of the display module 260 in order to notify of the second input. At this time, if swiping is normally performed as indicated by reference numeral 1321, the processor 210 displays a fingerprint in the predetermined form in a fingerprint display area 1302 of the display module 260. The fingerprint displayed on the display module 260 may be some pieces of information of the fingerprint rather than the entire fingerprint, and may be configured to include the same form as that of FIG. 13A or to include more information than the form illustrated in FIG. 13A. When only some pieces of the information are displayed after the second input, all pieces of information of the fingerprint data are intended to be displayed after all inputs are entered.

When the third input is received after the second input, as illustrated in FIG. 13C, in a state in which the input request window for requesting an input of a fingerprint is being displayed, the processor 210 displays an input step indicated by reference numerals 1313a and 1313b in a predetermined area of the display module 260 in order to notify of the third input.

If swiping is normally performed as indicated by reference numeral 1322 while the input request window and the input step are being displayed as described above, the processor 210 displays a fingerprint in the predetermined form in a fingerprint display area 1303 of the display module 260. The fingerprint displayed on the display module 260 may be some pieces of information of the fingerprint rather than the entire fingerprint, and may be configured to include the same form as that of FIG. 13A or to include more information than the form illustrated in FIG. 13B.

When the fourth input is received after the third input is completed through swipe 1323, as illustrated in FIG. 13D, the processor 210 displays the completed fingerprint in a fingerprint display window 1304 of the display module 260. The fingerprint completed as described above may be stored in the memory 401, as described above with reference to FIG. 4. At this time, the fingerprint data may be stored in the memory 401 while being encrypted using encryption information acquired from the security medium 460. The reason for encrypting and then storing the fingerprint data is to enhance security of the biometric data.

FIGS. 13E and 13F illustrate a case in which there is an erroneous input in the step of FIG. 13B.

Referring to FIG. 13E, when a user swipes a finger over the biometric sensor 403 while the finger is leaning toward a left side of the biometric sensor 403 as indicated by reference numeral 1324, the biometric sensor 403 does not acquire enough biometric data to recognize a fingerprint. When the erroneous swipe operation is performed as described above, the processor 210 notifies a user that the error has occurred, as illustrated in FIG. 13F. For example, an error message is displayed in text form on the display module 260, as indicated by reference numeral 1331. Furthermore, in order to notify of the error, the electronic device controls the motor 298 to output a vibration in a form through which the user is notified that the input has leaned toward the left, for example, in a form indicated by reference numeral 1341. Moreover, as indicated by reference numeral 1342, the electronic device controls the speaker 282 to output an alarm sound so as to notify the user that the user input has leaned too much toward the left. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Fingerprint has been input too much toward the left” or “Please swipe a finger over the center of the biometric sensor”.

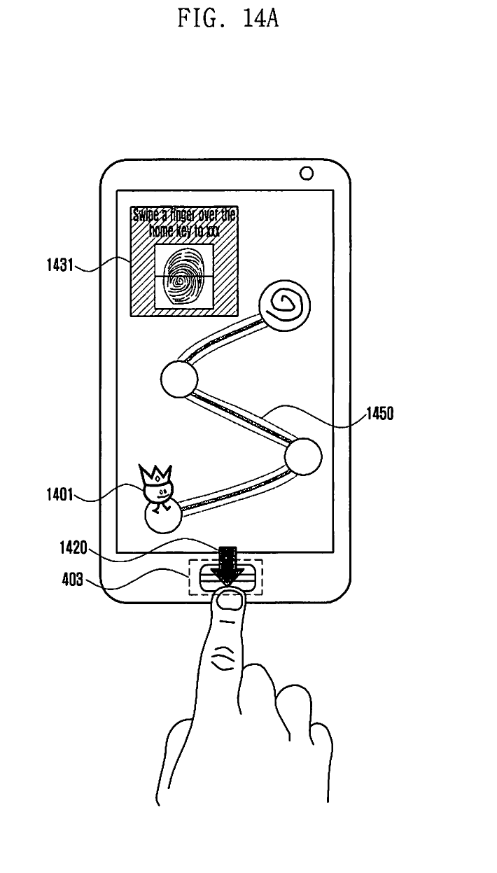

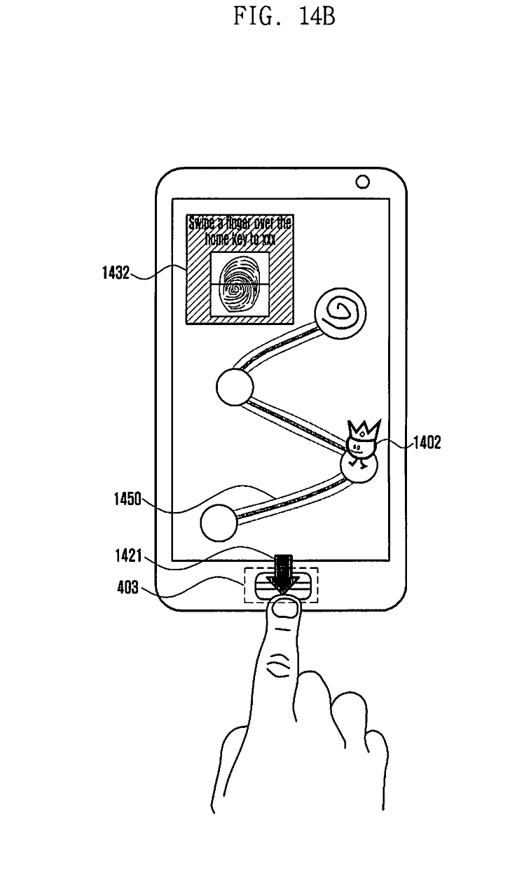

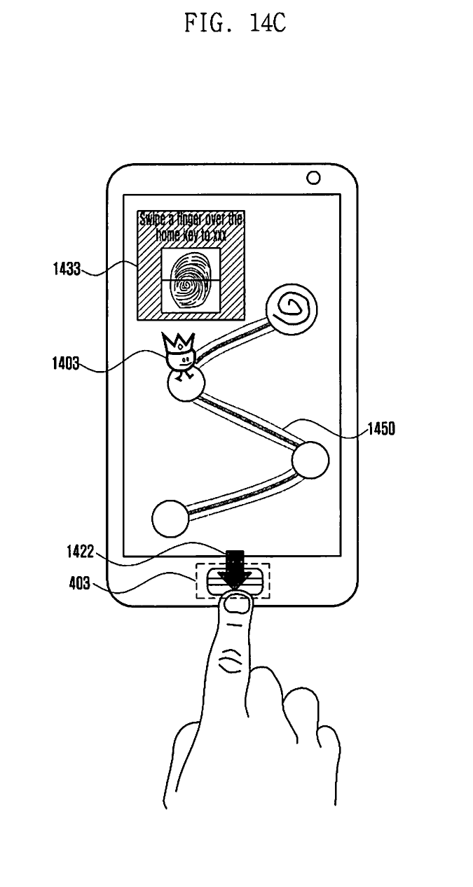

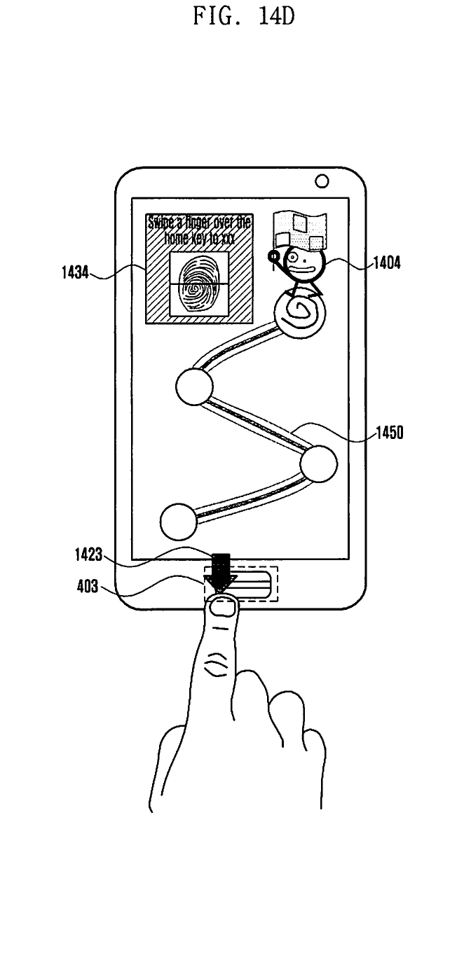

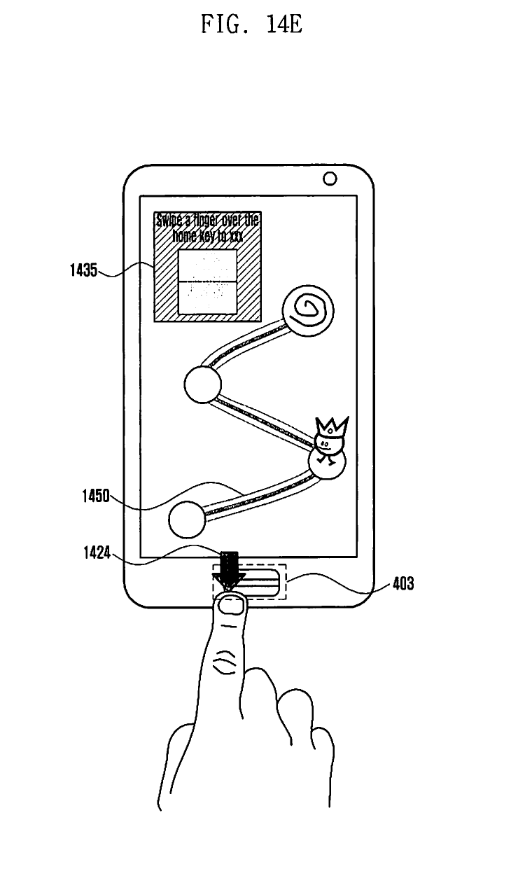

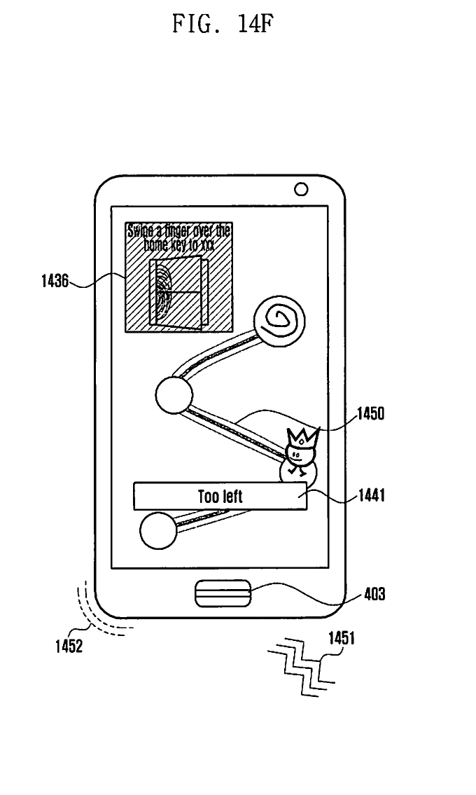

FIGS. 14A to 14F illustrate message output in response to a normal input and an erroneous input when biometric information is registered in an electronic device performing the biometrics, according to an embodiment of the present invention.

FIGS. 14A to 14D illustrate a case in which an input is entered four times and the inputs are normally and continuously made when biometric information is registered in an electronic device performing biometrics. Referring to FIGS. 14A to 14D, a guideline 1450 is illustrated for notifying of completion of a fingerprint which a user will register. The electronic device intuitively notifies the user of a state of a fingerprint input, while moving input number display windows, which can notify of the number of inputs, along the guideline 1450.

Referring to FIG. 14A, the processor 210 receives biometric information through the biometric sensor 403 illustrated in FIG. 4. At this time, a user inputs a fingerprint by swiping a finger over the biometric sensor 403, as indicated by reference numeral 1420. The operation of recognizing the fingerprint by the biometric sensor 403 has been described above with reference to FIG. 4.

In FIG. 14A, while an input request window for requesting an input of a fingerprint is being displayed, the processor 210 displays an input step indicated by reference numeral 1401 at a specific location on the guideline 1450 in a predetermined area of the display module 260, in order to notify of the first input. At this time, if swiping is normally performed as indicated by reference numeral 1420, the processor 210 displays a fingerprint in the predetermined form in a fingerprint display area 1431 of the display module 260. The fingerprint displayed on the display module 260 may be the currently acquired fingerprint data or some pieces of information of the fingerprint data to be stored. When only some pieces of the information are displayed after the first input, all pieces of information of the fingerprint data are intended to be displayed after all inputs are entered.

When the second input is received after the first input, as illustrated in FIG. 14B, in a state in which the input request window for requesting an input of a fingerprint is being displayed, the processor 210 displays an input step indicated by reference numerals 1402 in a predetermined area of the display module 260 in order to notify of the second input. That is, the processor 210 intuitively notifies the user of the second input by moving an image of animation. At this time, if swiping is normally performed as indicated by reference numeral 1421, the processor 210 may display the entire acquired fingerprint or some pieces of information of the fingerprint data for storage in a fingerprint display area 1432 of the display module 260. When some pieces of data rather than the entire acquired fingerprint data are displayed on the display module 260, the fingerprint displayed on the display module 260 may be configured to include the same form as that of FIG. 14A or to include more information than the form illustrated in FIG. 14A. When only some pieces of the information are displayed after the second input, all pieces of information of the fingerprint data are intended to be displayed after all inputs are entered.

When the third input is received after the second input is completed, as illustrated in FIG. 14C, the processor 210 displays an input step indicated by reference numeral 1403 in a predetermined area of the display module 260 in order to notify of the third input. If swiping is normally performed, as indicated by reference numeral 1422, while the input step is being displayed as described above, the processor 210 displays a fingerprint in the predetermined form in a fingerprint display area 1433 of the display module 260. The fingerprint displayed on the display module 260 may be the entire acquired fingerprint or some pieces of information on the fingerprint for storage, and may be configured to include the same form as that of FIG. 14A or to include more information than the form illustrated in FIG. 14B.

When the fourth input is received after the third input is completed through swipe 1423, as illustrated in FIG. 14D, the processor 210 displays an animation 1404 on the display module 260 such that a goal is represented at the final location on the guideline 1450, and displays the currently acquired fingerprint or the completed fingerprint for storage in a fingerprint display window 1434. The fingerprint completed as described above may be stored in the memory 401 as described above with reference to FIG. 4. The fingerprint data may be stored in the memory 401 while being encrypted using encryption information acquired from the security medium 460. The reason for encrypting and then storing the fingerprint data is to enhance security of the biometric data.

FIGS. 14E and 14F illustrate a case in which there is an erroneous input in the step of FIG. 14B.

Referring to FIG. 14E, the processor 210 may control to display the example of input scheme as a fingerprint in the predetermined form in a fingerprint display area 1435 of the display module 260. When a user swipes a finger over the biometric sensor 403 while the finger is leaning toward a left side of the biometric sensor 403, as indicated by reference numeral 1424, the biometric sensor 403 does not acquire enough biometric data to recognize a fingerprint. When the erroneous swipe operation is performed as described above, the processor 210 notifies a user that the error has occurred, as illustrated in FIG. 14F. For example, an error message is displayed in text form on the display module 260, as indicated by reference numeral 1441 and 1436. Furthermore, in order to notify of the error, the electronic device controls the motor 298 to output a vibration in a form through which the user is notified that the input has leaned toward the left, for example, in a form indicated by reference numeral 1452. Moreover, as indicated by reference numeral 1451, the electronic device controls the speaker 282 to output an alarm sound so as to notify the user that the user input has leaned too much toward the left. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Fingerprint has been input too much toward the left” or “Please swipe a finger over the center of the biometric sensor”.

The user is notified of other types of errors in such a way identical or similar to that for the above-described authentication operation.

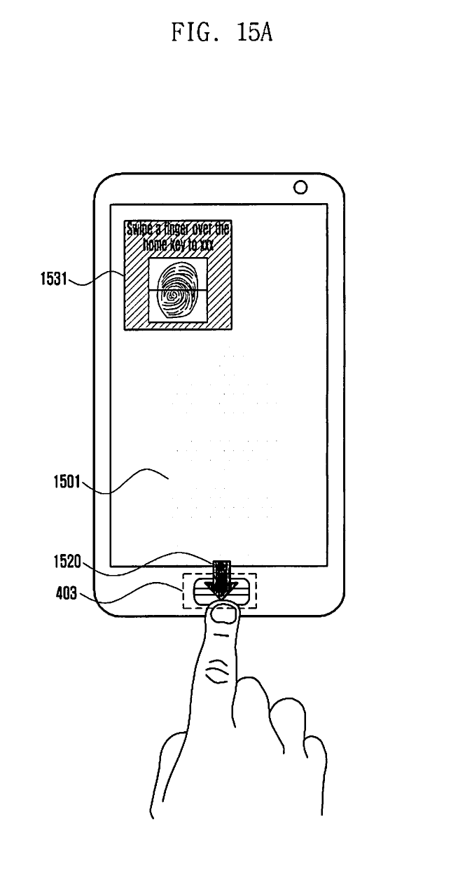

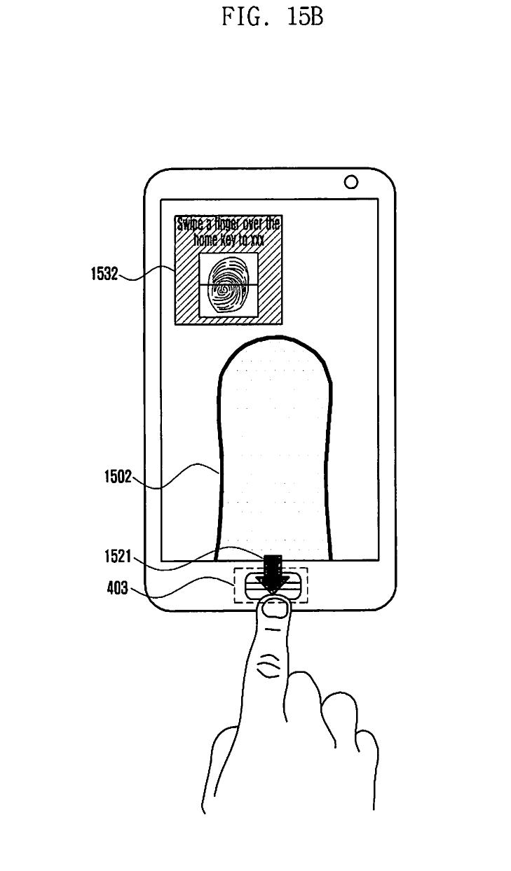

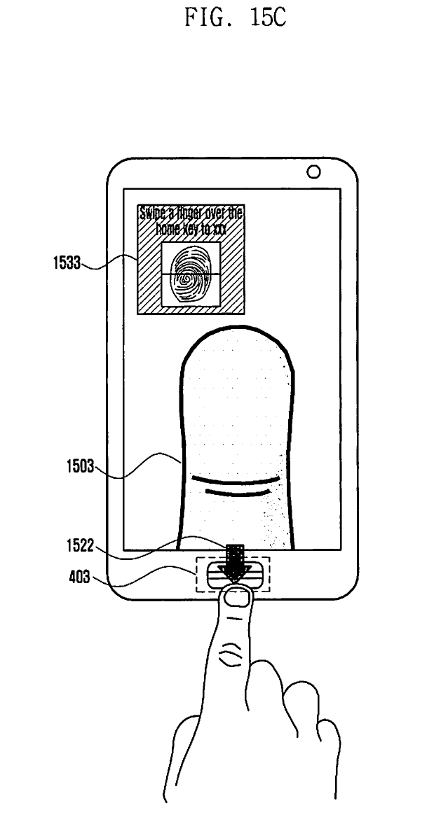

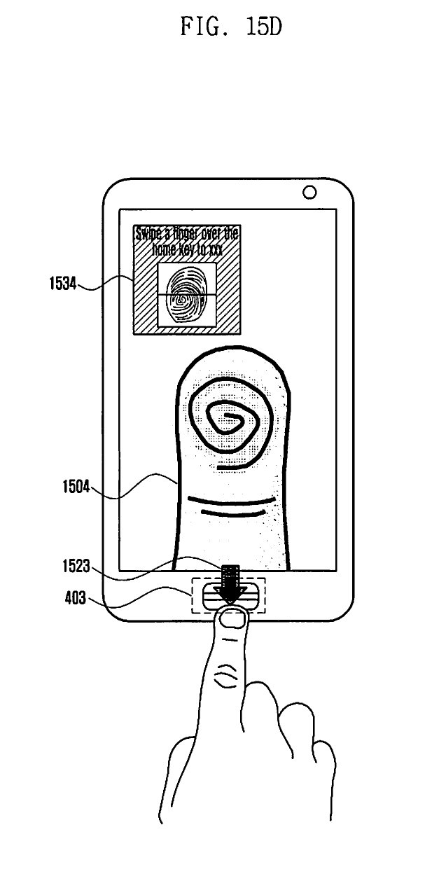

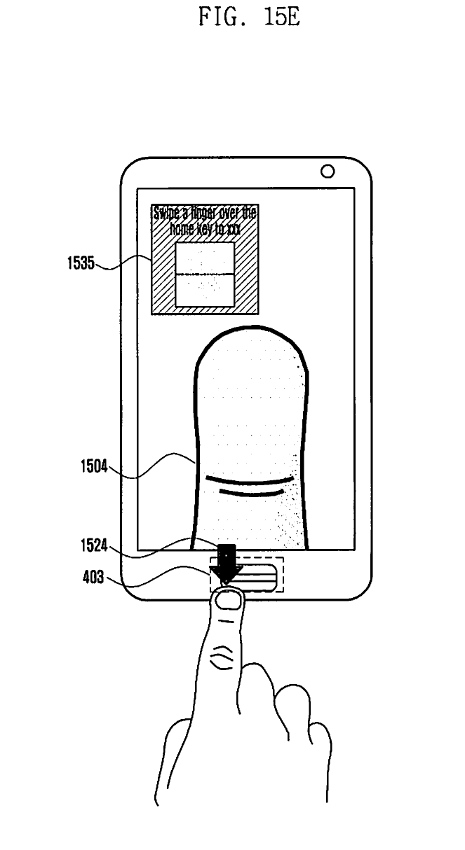

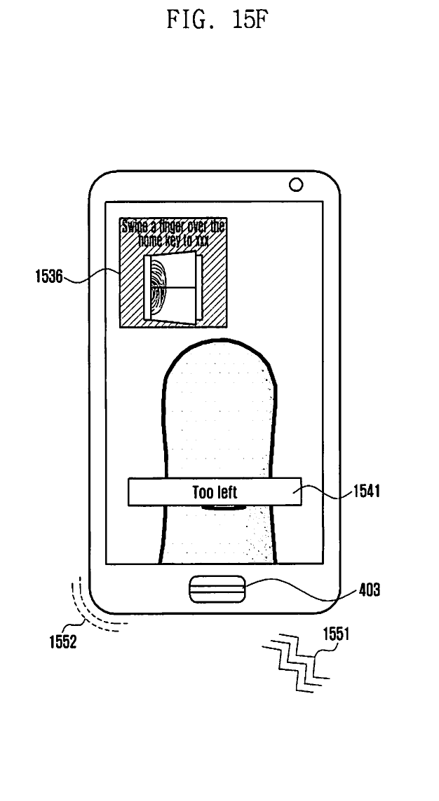

FIGS. 15A to 15F illustrate message output in response to a normal input and an erroneous input when biometric information is registered in an electronic device performing the biometrics, according to an embodiment of the present invention.

FIGS. 15A to 15D illustrate a case in which an input is entered four times and the inputs are normally and continuously made when biometric information is registered in an electronic device performing biometrics. Referring to FIGS. 15A to 15D, as a guide for notifying of completion of a fingerprint which a user will register, a finger shape is displayed at a predetermined location of the display module 260. Furthermore, the guide is provided to the user in such a manner that the finger shape is filled with forms that correspond to the number of inputs. This helps the user to be intuitively notified of the progress of the registration procedure.

Referring to FIG. 15A, the processor 210 receives biometric information through the biometric sensor 403 illustrated in FIG. 4. At this time, a user inputs a fingerprint by swiping a finger over the biometric sensor 403, as indicated by reference numeral 1520. The fingerprint data acquired as described above is displayed in a fingerprint display window 1531. Even in this case, the entire acquired fingerprint data may be displayed, or the fingerprint may be gradually completed.

In FIG. 15A, while an input request window for requesting an input of a fingerprint is being displayed, the processor 210 displays only a shape of a finger as indicated by reference numeral 1501 in a predetermined area of the display module 260 in order to notify of the first input.

When the second input is received after the first input is completed, as illustrated in FIG. 14B, the processor 210 modifies a contour of the finger displayed on the display module 260 for display, as shown with reference numeral 1502. This is to intuitively notify a user of the second input.

At this time, if swiping is normally performed as indicated by reference numeral 1521, the processor 210 displays the entire acquired fingerprint or some pieces of information on the fingerprint data for storage in a fingerprint display area 1532 of the display module 260. When some pieces of data rather than the entire acquired fingerprint data are displayed on the display module 260, the fingerprint displayed on the display module 260 may be configured to include the same form as that of FIG. 15A or to include more information than the form illustrated in FIG. 15A. When only some pieces of the information are displayed after the second input, all pieces of information of the fingerprint data are intended to be displayed after all inputs are entered.

Furthermore, when the third input is received after the second input is completed, as illustrated in FIG. 15C, the processor 210 displays more detailed information on the finger shape, indicated by reference numeral 1503, in a predetermined area of the display module 260, in order to notify of the third input. If swiping is normally performed as indicated by reference numeral 1522 while the more detailed information is displayed as described above, the processor 210 displays a fingerprint in the predetermined form in a fingerprint display area 1533 of the display module 260. The fingerprint displayed on the display module 260 may be the entire acquired fingerprint or some pieces of information on the fingerprint for storage, and may be configured to include the same form as that of FIG. 15A or to include more information than the form illustrated in FIG. 15B.

When the fourth input is received after the third input is completed through swiping indicated by reference numeral 1523, as illustrated in FIG. 15D, the processor 210 displays the completed finger shape, as indicated by reference numeral 1504, on the display module 260. Furthermore, the currently acquired fingerprint or the completed fingerprint to be stored is displayed in a fingerprint display window 1534. The fingerprint completed as described above may be stored in the memory 401 as described above with reference to FIG. 4. At this time, the fingerprint data may be stored in the memory 401 while being encrypted using encryption information acquired from the security medium 460. The reason for encrypting and then storing the fingerprint data is to enhance security of the biometric data.

FIGS. 15E and 15F illustrate a case in which there is an erroneous input in the step of FIG. 15B.

Referring to FIG. 15E, the processor 210 may control to display the example of input scheme as a fingerprint in the predetermined form in a fingerprint display area 1435 of the display module 260. When a user swipes a finger over the biometric sensor 403 while the finger is leaning toward a left side of the biometric sensor 403 as indicated by reference numeral 1524, the biometric sensor 403 does not acquire enough biometric data to recognize a fingerprint. When the erroneous swipe operation is performed as described above, the processor 210 notifies a user that the error has occurred, as illustrated in FIG. 15F. For example, an error message is displayed in a text form on the display module 260, as indicated by reference numeral 1541. Furthermore, in order to notify of the error, the electronic device controls the motor 298 to output a vibration in a form through which the user is notified that the input has leaned toward the left, for example, in a form indicated by reference numeral 1552 and 1536. Moreover, as indicated by reference numeral 1551, the electronic device controls the speaker 282 to output an alarm sound so as to notify the user that the user input has leaned too much toward the left. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Fingerprint has been input too much toward the left” or “Please swipe a finger over the center of the biometric sensor”.

The user may be notified of other types of errors in such a way identical or similar to that for the above-described authentication operation.

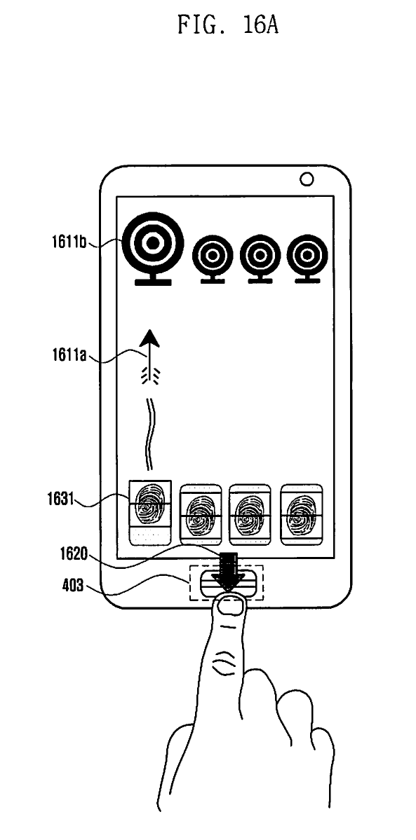

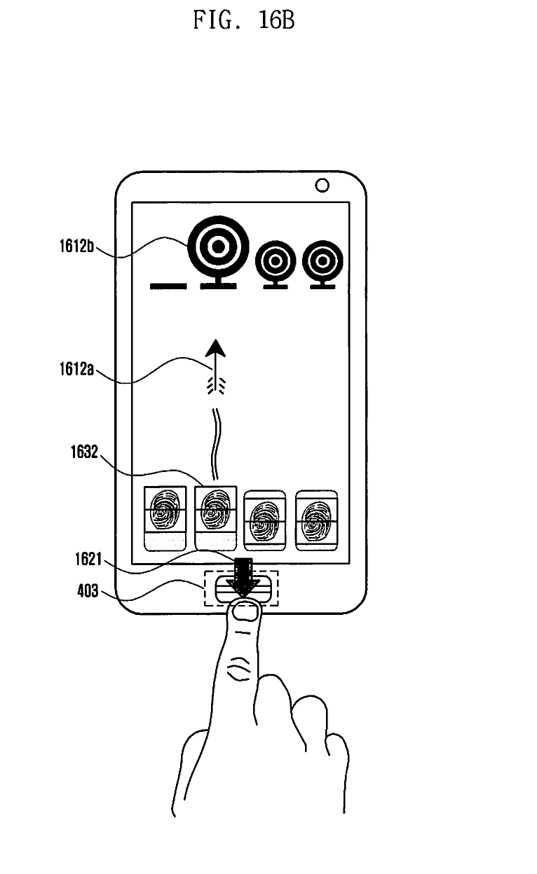

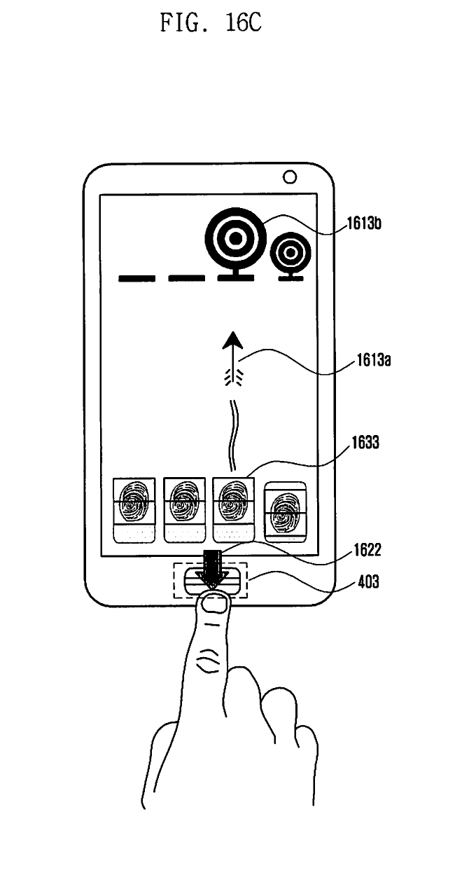

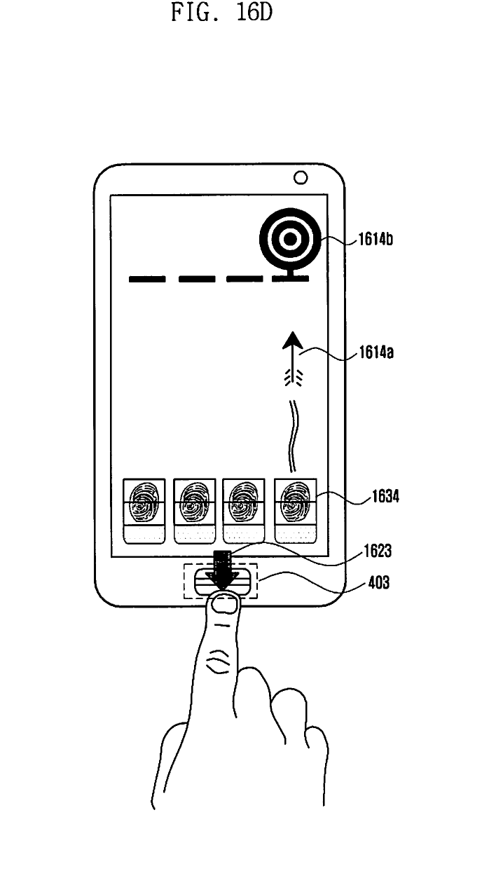

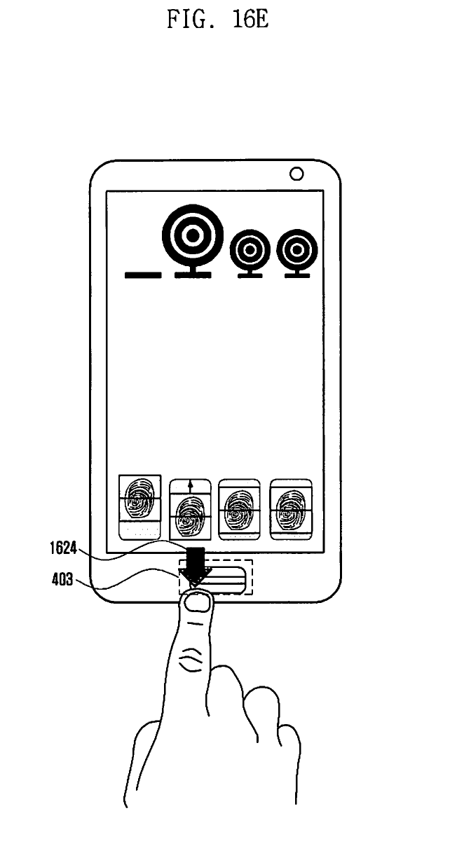

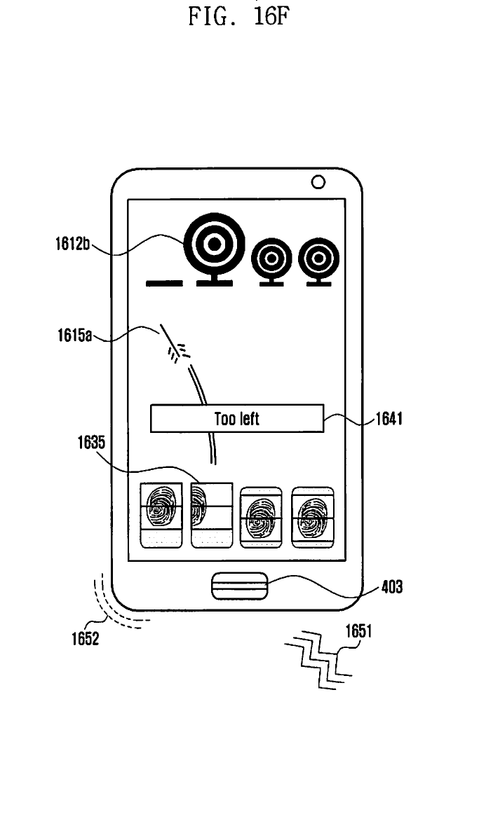

FIGS. 16A to 16F illustrate message output in response to a normal input and an erroneous input when biometric information is registered in an electronic device performing the biometrics, according to an embodiment of the present invention.

FIGS. 16A to 16D illustrate a case in which an input is entered four times and the inputs are normally and continuously made when biometric information is registered in an electronic device performing biometrics. Referring to FIGS. 16A to 16D, targets corresponding to the number of inputs are displayed at predetermined locations of the display module 260. A target corresponding to the present input is displayed to be larger than other targets. This may help a user intuitively recognize the present input step.

Referring to FIG. 16A, the processor 210 receives biometric information through the biometric sensor 403 illustrated in FIG. 4. At this time, a user inputs a fingerprint by swiping a finger over the biometric sensor 403, as indicated by reference numeral 1620. The fingerprint data acquired as described above is displayed in a fingerprint display window 1631. Furthermore, likewise to the aforementioned authentication process, an arrow is displayed as if hitting the corresponding target right in the center, crossing the target, veering away from the target, or not reaching the target in response to the swiping operation. When the first swiping operation 1620 is normally performed, the processor 210 controls displaying of the display module 260 such that a first arrow 1611a hits a first target 1611b right in the center and then disappears.

Fingerprint display windows are displayed to correspond to the number of inputs, and therefore, in contrast to the above description, all pieces of fingerprint data acquired in correspondence to the respective inputs are displayed. However, it is apparent to those skilled in the related art that only some pieces of fingerprint data acquired in correspondence to the respective inputs may also be displayed.

FIG. 16B illustrates a case in which the second fingerprint is input. When a swiping operation is performed, as indicated by reference numeral 1621, a second arrow 1612a is displayed as if hitting a corresponding target 1612b right in the center, crossing the target, veering away from the target, or not reaching the target in response to the swiping operation. When the second swiping operation 1621 is normally performed, the processor 210 controls displaying of the display module 260 such that the second arrow 1612a hits the second target 1612b right in the center and then disappears. Furthermore, the processor 210 allows the acquired fingerprint data to be displayed in a fingerprint display window 1632.

FIG. 16C illustrates a case in which the third fingerprint is input. When a swiping operation is performed, as indicated by reference numeral 1622, a third arrow 1613a is displayed as if hitting a corresponding target 1613b right in the center, crossing the target, veering away from the target, or not reaching the target in response to the swiping operation. When the third swiping operation 1622 is normally performed, the processor 210 controls displaying of the display module 260 such that the third arrow 1613a hits the third target 1613b right in the center and then disappears. Furthermore, the processor 210 allows the acquired fingerprint data to be displayed in a fingerprint display window 1633.

FIG. 16D illustrates a case in which the fourth fingerprint is input. When a swiping operation is performed, as indicated by reference numeral 1623, a fourth arrow 1614a is displayed as if hitting a corresponding target 1614b right in the center, crossing the target, veering away from the target, or not reaching the target in response to the swiping operation. When the fourth swiping operation 1623 is normally performed, the processor 210 controls displaying of the display module 260 such that the fourth arrow 1614a hits the fourth target 1614b right in the center and then disappears. Furthermore, the processor 210 allows the acquired fingerprint data to be displayed in a fingerprint display window 1634.

FIGS. 16E and 16F illustrate a case in which there is an erroneous input in the step of FIG. 16B.

Referring to FIG. 16E, when a user swipes a finger over the biometric sensor 403 while the finger is leaning toward a left side of the biometric sensor 403, as indicated by reference numeral 1624, the biometric sensor 403 does not acquire enough biometric data to recognize a fingerprint. When the erroneous swipe operation is performed as described above, the processor 210 notifies a user that the error has occurred, as illustrated in FIG. 16F. For example, an error message is displayed in text form on the display module 260, as indicated by reference numeral 1641. Furthermore, in order to notify of the error, the electronic device controls the motor 298 to output a vibration in a form through which the user is notified that the input has leaned toward the left, for example, in a form indicated by reference numeral 1652 and 1635. Moreover, as indicated by reference numeral 1651, the electronic device controls the speaker 282 to output an alarm sound so as to notify the user that the user input has leaned too much toward the left. It is assumed that the speaker 282 may output an alarm sound by differentiating at least two or more of the left side, the right side, the top side, and the bottom side of the electronic device. When the speaker 282 is configured with one speaker, the speaker 282 may also output a voice message “Fingerprint has been input too much toward the left” or “Please swipe a finger over the center of the biometric sensor”.

In addition, an arrow 1615a is displayed to fly to the target while missing toward the left. The user may be notified of other types of errors in such a way identical or similar to that for the above-described authentication operation.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method of operating an electronic device, the method comprising the steps of:
recognizing, by the electronic device, biometric data of a user that is input to the electronic device; and
presenting, to the user, information related to an input error of the biometric data based on the recognition of the biometric data.

2. The method of claim 1, wherein presenting the information comprises:
presenting the information with at least one of text, vibration, sound, graphics, and animation.

3. The method of claim 1, wherein recognizing the biometric data comprises:
reconfiguring the biometric data into a preconfigured format of image data; and
extracting one or more features from the reconfigured biometric data for biometric authentication.

4. The method of claim 1, wherein the biometric data comprises data for at least one of a fingerprint, an iris, a vein, and an ear of the user.

5. The method of claim 4, wherein the input error is a result of at least one of:
the biometric data input at a speed higher than an input speed in a pre-defined range;
the biometric data input at a speed lower than the input speed in the pre-defined range;
at least one portion of the biometric data input while leaning toward a left or right side of a pre-defined input area;
the biometric data input with a contact strength higher than a pre-defined contact strength;
the biometric data input over a time longer than a pre-defined time interval for which the biometric data is to be recognized;
the biometric data input while a recognition module for receiving the biometric data is not ready;
the biometric data input while at least a part of a body of the user corresponding to the biometric data has a humidity higher than pre-defined humidity; and
the biometric data input is narrower than a pre-defined contact width.

6. The method of claim 1, wherein the biometric data is acquired for unlocking the electronic device.

7. The method of claim 6, further comprising:
reading and decoding pre-stored biometric data when there is no input error in the biometric data;
comparing the decoded pre-stored biometric data with the biometric data and determining whether the decoded pre-stored biometric data and the biometric data match; and
providing a result of the determination.

8. The method of claim 7, wherein, when the pre-stored biometric data is read and decoded, security data is acquired from a security medium and the pre-stored biometric data is decoded using the acquired security data.

9. The method of claim 1, wherein the biometric data is acquired for registration of the biometric data.

10. The method of claim 9, further comprising:
acquiring security data from a security medium, when registering the biometric data;
encrypting the biometric data using the acquired security data; and
storing the encrypted biometric data.

11. An electronic device comprising:
a recognition module configured to recognize biometric data of at least a part of a body of a user that is input to the electronic device;
an output module configured to present information related to the biometric data to the user; and
a control module configured to output error information corresponding to an input error of the biometric data through the output module when the input error of the biometric data is sensed based on the recognition.

12. The electronic device of claim 11, wherein the error information comprises at least one of text corresponding to the error information, a vibration corresponding to the error information, a sound corresponding to the error information, graphics corresponding to the error information, and an animation corresponding to the error information.

13. The electronic device of claim 11, wherein the control module is further configured to reconfigure the biometric data as image data with a preconfigured size and a preconfigured form, and to extract a feature from the reconfigured biometric data.

14. The electronic device of claim 11, wherein the biometric data comprises fingerprint recognition data.

15. The electronic device of claim 14, wherein the input error is a result of at least one of:
the biometric data entered too fast;
the biometric data entered for too short a period of time;
the biometric data entered too slow;
the biometric data entered leaning too much toward a left or right side;
the biometric data entered with too much pressure;
the biometric data entered for too long a period of time;
the biometric data entered while a sensor is not ready;
the biometric data entered in a wet state; and
the biometric data entered in too narrow a range.

16. The electronic device of claim 11, wherein the biometric data is acquired for unlocking the electronic device.

17. The electronic device of claim 16, wherein, when there is no error in the acquired biometric data, the control module is further configured to read and decode pre-stored biometric data, compare the decoded pre-stored biometric data with the biometric data to determine whether the decoded pre-stored biometric data and the biometric data match, and output a result of the determination though the output module.

18. The electronic device of claim 17, wherein, when reading and decoding the pre-stored biometric data, the control module is further configured to acquire security data from a security medium and decode the pre-stored biometric data using the acquired security data.

19. The electronic device of claim 11, wherein the processor acquires the biometric data when registering the biometric data.

20. The electronic device of claim 19, further comprising:
a memory for storing the biometric data,
wherein, when registering the biometric data, the control module is further configured to acquire security data from a security medium, encrypt the biometric data using the acquired security data, and store the encrypted biometric data.

21. A method for operating an electronic device, the method comprising the steps of:
recognizing, by the electronic device, a plurality of pieces of biometric data corresponding to a specific body part of a user based on a plurality of inputs to the electronic device; and
for each of the plurality of pieces of biometric data, presenting, to the user, at least one of information as to whether recognition succeeds, information on an error occurring during the recognition, and information on a result obtained by comparing a first of the plurality of pieces of biometric data corresponding to a first of the plurality of inputs and a second of the plurality of pieces of biometric data corresponding to a second of the plurality of inputs.

22. The method of claim 21, further comprising:
storing at least one of the first and the second of the plurality of pieces of biometric data as data for authentication of the user, based on the result obtained by comparing the first and the second of the plurality of pieces of biometric data.

23. The method of claim 22, wherein storing the at least one of the first and the second of the plurality of pieces of biometric data comprises:
storing the first of the plurality of pieces of biometric data as effective data for the authentication of the user, when the first of the plurality of pieces of biometric data is successfully recognized; and
storing the second of the plurality of pieces of biometric data as the effective data, when the second of the plurality of pieces of biometric data is successfully recognized and a validity of the second of the plurality of pieces of biometric data is acknowledged according to the result obtained by comparing the first and the second of the plurality of pieces of biometric data.

24. The method of claim 21, wherein presenting the information as to whether the recognition succeeds comprises:
presenting, to the user, that the first of the plurality of pieces of biometric data is stored as effective data for authentication of the user when the first of the plurality of pieces of biometric data is successfully recognized; and
presenting, to the user, that the second of the plurality of pieces of biometric data is stored as the effective data when the second of the plurality of pieces of biometric data is successfully recognized and a validity of the second of the plurality of pieces of biometric data is acknowledged according to the result obtained by comparing the first and the second of the plurality of pieces of biometric data.
